(19) United States
(12) Patent Application Publication
(10) Pub. No.: US 2023/0289126 A1
(43) Pub. Date: Sep. 14, 2023

(54) SYSTEM, METHOD FOR ADJUSTING AUDIO VOLUME, AND APPARATUS

(71) Applicants: Fumihiko MINAGAWA, Chiba (JP); Takahiro KAMEKURA, Tokyo (JP); Shigeyuki ISHII, Ibaraki (JP)

(72) Inventors: Fumihiko MINAGAWA, Chiba (JP); Takahiro KAMEKURA, Tokyo (JP); Shigeyuki ISHII, Ibaraki (JP)

(21) Appl. No.: 18/114,279

(22) Filed: Feb. 27, 2023

(30) Foreign Application Priority Data
Mar. 8, 2022 (JP) 2022-035356

(51) Int. Cl. G06F 3/14

(52) U.S. Cl. CPC G06F 3/1462; G06F 3/1423

(57) ABSTRACT

A system includes a first apparatus and a second apparatus. The first apparatus includes first circuitry to input and output audio, acquire information on the second apparatus output from the second apparatus, and transmit the information on the second apparatus acquired from the second apparatus to a terminal apparatus. The second apparatus includes second circuitry to input and output audio, output the information on the second apparatus, and in response to a request for adjusting audio volume of the second apparatus received from the terminal apparatus via a network, adjust the volume of at least one of the audio input by the second apparatus or the audio output by the second apparatus.

### CROSS-REFERENCE TO RELATED APPLICATIONS

This patent application is based on and claims priority pursuant to 35 U.S.C. § 119(a) to Japanese Patent Application No. 2022-035356, filed on Mar. 8, 2022, in the Japan Patent Office, the entire disclosure of which is hereby incorporated by reference herein.

### BACKGROUND

### Technical Field

The present disclosure relates to a system, a method for adjusting audio volume, and apparatuses.

### Related Art

Known remote communication systems transmit images and audio from one site to one or more other sites in real time to allow users at remote sites to hold a conference using the images and the audio. In such remote communication systems, a device such as an electronic whiteboard located at a conference room is sometimes used.

There has been known a technique for eliminating or reducing howling generated by a plurality of devices located in a conference room. For example, there is known a technique for eliminating or reducing howling by muting one of terminals at a certain distance from each other.

### SUMMARY

In one aspect, a system includes a first apparatus and a second apparatus. The first apparatus includes first circuitry to input and output audio, acquire information on the second apparatus output from the second apparatus, and transmit the information on the second apparatus acquired from the second apparatus to a terminal apparatus. The second apparatus includes second circuitry to input and output audio, output the information on the second apparatus, and in response to a request for adjusting audio volume of the second apparatus received from the terminal apparatus via a network, adjust the volume of at least one of the audio input by the second apparatus or the audio output by the second apparatus.

In another aspect, a system includes a first apparatus and a second apparatus. The first apparatus includes first circuitry to input and output audio, acquire information on the second apparatus output from the second apparatus, and transmit the information on the second apparatus acquired from the second apparatus to a network. The second apparatus includes second circuitry to input and output audio, output the information on the second apparatus, and in response to a request for adjusting audio volume of the second apparatus received via the network, adjust the volume of at least one of the audio input by the second apparatus or the audio output by the second apparatus.

In another aspect, a method for adjusting audio volume performed by a system including a first apparatus that inputs and outputs audio and a second apparatus that inputs and outputs audio includes outputting information on the second apparatus from the second apparatus, with the first apparatus, acquiring the information on the second apparatus output from the second apparatus, transmitting, from the first apparatus to a terminal apparatus, the information on the second apparatus acquired from the second apparatus, and in response to a request for adjusting audio volume of the second apparatus received from the terminal apparatus via a network, adjusting the volume of at least one of the audio input by the second apparatus or the audio output by the second apparatus.

In another aspect, an apparatus includes circuitry to communicate, via a network, with another apparatus that inputs and outputs audio, input and output audio, output information on the apparatus to another apparatus, the information on the apparatus being transmitted from the another apparatus to a terminal apparatus, and in response to a request for adjusting audio volume of the apparatus received from the terminal apparatus via the network, adjust the volume of at least one of the audio input by the apparatus or the audio output by the apparatus, the terminal apparatus having received, from a user, a request for participation of the another apparatus in a communication in which the apparatus participates.

In another aspect, an apparatus includes circuitry to communicate, via a network, with another apparatus that inputs and outputs audio, input and output audio, acquire information on the another apparatus output from the another apparatus, and transmit the information on the another apparatus acquired from the another apparatus to a terminal apparatus having received, from a user, a request for participation of the apparatus in a communication in which the another apparatus participates.

In another aspect, an apparatus includes circuitry to communicate with another apparatus that inputs and outputs audio, input and output audio, acquire information on the another apparatus output from the another apparatus, and in accordance with the information on the another apparatus acquired from the another apparatus, adjust volume of at least one of the audio input by the apparatus or the audio output by the apparatus.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating an outline of creating a record of conference including a screen of an application executed in a teleconference together with a panoramic image of the surroundings according to one embodiment of the present disclosure:

FIG. 2 is a schematic diagram illustrating processing executed by a terminal apparatus to mute a microphone and a speaker of an electronic whiteboard according to one embodiment of the present disclosure;

FIG. 3 is a schematic diagram illustrating an example of a configuration of an information recording system according to one embodiment of the present disclosure;

FIG. 4 is a block diagram illustrating an example of a hardware configuration of an information processing system and a terminal apparatus according to one embodiment of the present disclosure;

FIG. 5 is a block diagram illustrating an example of a hardware configuration of a meeting device according to one embodiment of the present disclosure;

FIG. 6 is a schematic diagram illustrating an imaging range of the meeting device according to one embodiment of the present disclosure;

FIG. 7 is a schematic diagram illustrating a panoramic image and processing to cut out talker images from the panoramic image according to one embodiment of the present disclosure:

FIG. 8 is a block diagram illustrating a hardware configuration of the electronic whiteboard according to one embodiment of the present disclosure:

FIG. 9 is a block diagram illustrating functional configurations of the terminal apparatus, the meeting device, and the information processing system in the information recording system according to one embodiment of the present disclosure;

FIG. 10 is a table illustrating an example of a record of moving image stored in an information storage unit according to one embodiment of the present disclosure;

FIG. 11 is a table illustrating an example of conference information managed by a communication management unit according to one embodiment of the present disclosure;

FIG. 12 is a table illustrating an example of association information, which is stored in an association information storage unit, associating a conference identification (ID) with device identifiers according to one embodiment of the present disclosure:

FIG. 13 is a block diagram illustrating functional configurations of the electronic whiteboard according to one embodiment of the present disclosure;

FIG. 14 is a table illustrating an example of device identification information stored in a device information storage unit according to one embodiment of the present disclosure;

FIG. 15 is a table illustrating an example of object information stored in an object information storage unit according to one embodiment of the present disclosure:

FIG. 16 is a sequence chart illustrating an example of processing executed by the electronic whiteboard to mute audio input and output in response to participation in a conference (a muting procedure 1) according to one embodiment of the present disclosure:

FIG. 17 is a diagram illustrating an example of a screen for participating in a conference displayed by the terminal apparatus according to one embodiment of the present disclosure;

FIG. 18 is a diagram illustrating an example of a two-dimensional code displayed by the electronic whiteboard according to one embodiment of the present disclosure:

FIG. 19 is a schematic diagram illustrating an example of a method for displaying a two-dimensional code performed by the electronic whiteboard according to one embodiment of the present disclosure;

FIG. 20 is a schematic diagram illustrating another example of a method for displaying a two-dimensional code performed by the electronic whiteboard according to one embodiment of the present disclosure;

FIG. 21 is a schematic diagram illustrating still another example of a method for displaying a two-dimensional code performed by the electronic whiteboard according to one embodiment of the present disclosure;

FIG. 22 is a schematic diagram illustrating still another example of a method for displaying a two-dimensional code performed by the electronic whiteboard according to one embodiment of the present disclosure:

FIG. 23 is a schematic diagram illustrating still another example of a method for displaying a two-dimensional code performed by the electronic whiteboard according to one embodiment of the present disclosure:

FIG. 24 is a schematic diagram illustrating still another example of a method for displaying a two-dimensional code performed by the electronic whiteboard according to one embodiment of the present disclosure;

FIG. 25 is a schematic diagram illustrating an example of a method for displaying a two-dimensional code performed by the electronic whiteboard in a case where a camera included in the meeting device is a hemispherical camera according to one embodiment of the present disclosure;

FIG. 26 is a schematic diagram illustrating an example of a method for displaying a bar code performed by the electronic whiteboard according to one embodiment of the present disclosure;

FIG. 27 is a diagram illustrating an example of a screen displayed by the electronic whiteboard in a mute state according to one embodiment of the present disclosure:

FIG. 28 is a sequence chart illustrating another example of processing executed by the electronic whiteboard to mute audio input and output in response to participation in a conference (a muting procedure 2) according to one embodiment of the present disclosure:

FIG. 29 is a table illustrating an example of a format of an audio signal according to one embodiment of the present disclosure;

FIG. 30 is a sequence chart illustrating still another example of processing executed by the electronic whiteboard to mute audio input and output in response to participation in a conference (a muting procedure 3) according to one embodiment of the present disclosure;

FIG. 31 is a sequence chart illustrating still another example of processing executed by the electronic whiteboard to mute audio input and output in response to participation in a conference (a muting procedure 4) according to one embodiment of the present disclosure:

FIG. 32 is a diagram illustrating an example of a screen for starting device detection processing displayed by the terminal apparatus according to one embodiment of the present disclosure;

FIG. 33 is a sequence chart illustrating still another example of processing executed by the electronic whiteboard to mute audio input and output in response to participation in a conference (a muting procedure 5) according to one embodiment of the present disclosure;

FIG. 34 is a sequence chart illustrating still another example of processing executed by the electronic whiteboard to mute audio input and output in response to participation in a conference (a muting procedure 6) according to one embodiment of the present disclosure:

FIG. 35 is a sequence chart illustrating still another example of processing executed by the electronic whiteboard to mute audio input and output in response to participation in a conference (a muting procedure 7) according to one embodiment of the present disclosure:

FIG. 36 is a sequence chart illustrating still another example of processing executed by the electronic whiteboard to mute audio input and output in response to participation in a conference (a muting procedure 8) according to one embodiment of the present disclosure:

FIG. 37 is a sequence chart illustrating an example of processing of the electronic whiteboard to be unmuted when exiting from a conference (an unmuting procedure 1) according to one embodiment of the present disclosure:

FIG. 38 is a diagram illustrating an example of a screen for instructing an exit from a conference displayed by the electronic whiteboard according to one embodiment of the present disclosure;

FIG. 39 is a sequence chart illustrating another example of processing of the electronic whiteboard to be unmuted when the terminal apparatus exits from a conference (an unmuting procedure 2) according to one embodiment of the present disclosure;

FIG. 40 is a sequence chart illustrating an example of processing of the electronic whiteboard to be unmuted in a case where communication between the terminal apparatus and the information processing system is disconnected (an unmuting procedure 3) according to one embodiment of the present disclosure;

FIG. 41 is a sequence chart illustrating an example of processing executed by the electronic whiteboard to stop displaying a two-dimensional code without receiving a muting request after the electronic whiteboard is activated according to one embodiment of the present disclosure;

FIG. 42 is a diagram illustrating an example of an initial screen displayed by an information recording application operating on the terminal apparatus after a login according to one embodiment of the present disclosure;

FIG. 43 is a diagram illustrating an example of a record setting screen displayed by the information recording application according to one embodiment of the present disclosure;

FIG. 44 is a diagram illustrating an example of a recording screen displayed by the information recording application in recording according to one embodiment of the present disclosure;

FIG. 45 is a diagram illustrating an example of a conference list screen displayed by the information recording application according to one embodiment of the present disclosure; and

FIG. 46 is a sequence chart illustrating an example of processing executed by the information recording application to record a panoramic image, a talker image, and an application screen, according to one embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, descriptions are given of an information processing system and a method for adjusting audio volume performed by the information processing system as an exemplary embodiment of the present disclosure.

Example of Method for Creating Minutes of Teleconference

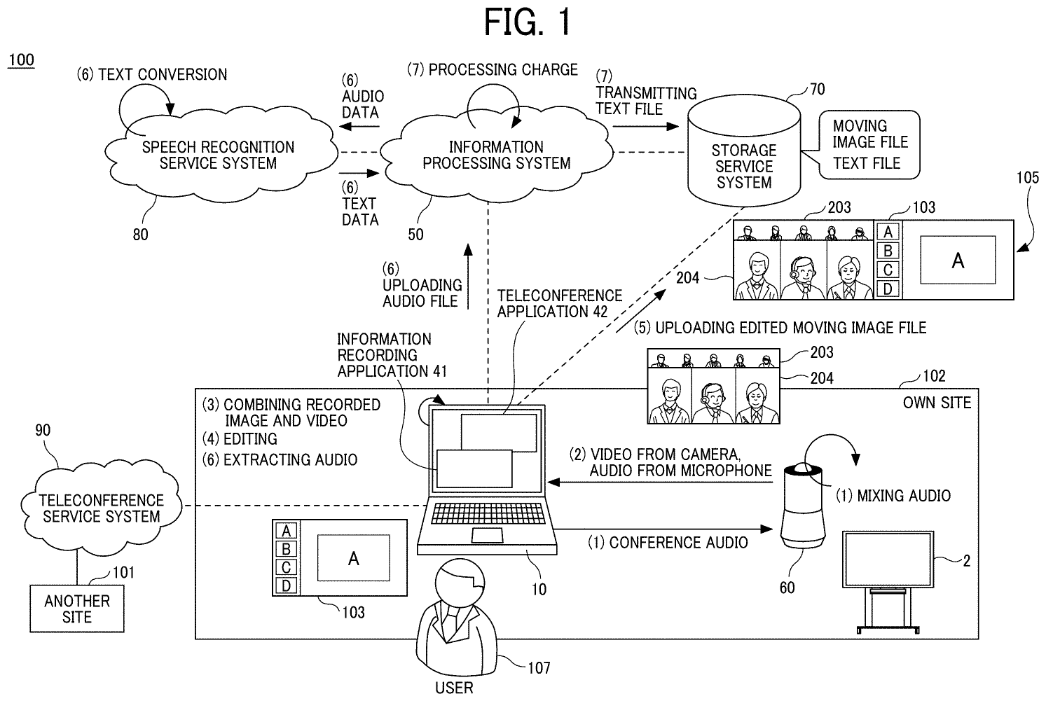

A description is now given of an outline of a method for creating minutes using a panoramic image and an application screen with reference to FIG. 1. FIG. 1 is a schematic diagram illustrating an outline of creating a record of conference including a screen of an application executed in a teleconference together with a panoramic image of the surroundings according to present embodiment. As illustrated in FIG. 1, a user at an own site 102 uses a teleconference service system 90 to hold a teleconference with another user at another site 101.

An information recording system 100 according to the present embodiment includes a meeting device 60 and a terminal apparatus 10. The meeting device 60 includes an imaging device that can capture an image of surroundings in 360 degrees, a microphone, and a speaker. The meeting device 60 processes image data obtained by capturing an image of surroundings in 360 degrees to generate a horizontal panoramic image (hereinafter referred to as a panoramic image). The information recording system 100 creates a record of conference (e.g., minutes) using the panoramic image and a screen generated by an application executed by the terminal apparatus 10. The information recording system 100 synthesizes audio data received by a teleconference application 42 and audio data acquired by the meeting device 60, and includes the resultant audio data in the record of conference. A description is given below of the outline of the method for creating the minutes.

(1) On the terminal apparatus 10, an information recording application 41 to be described later and the teleconference application 42 are operating. In addition, another application for displaying materials may also be operating on the terminal apparatus 10. The information recording application 41 transmits audio output from the terminal apparatus 10 (including audio received by the teleconference application 42 from the other site 101) to the meeting device 60. The meeting device 60 mixes (synthesizes) audio data acquired by the meeting device 60 and audio data received by the teleconference application 42.

(2) The meeting device 60 executes processing of cutting out an image of a talker from a panoramic image based on a direction in which audio is received by the microphone included in the meeting device 60 and generates a talker image. The meeting device 60 transmits both the panoramic image and the talker image to the terminal apparatus 10.

(3) The information recording application 41 operating on the terminal apparatus 10 can display a panoramic image 203 and a talker image 204. The information recording application 41 combines the panoramic image 203, the talker image 204, and an application screen freely selected by the user (e.g., an application screen 103 of the teleconference application 42). For example, the information recording application 41 combines the panoramic image 203, the talker images 204, and the application screen 103 of the teleconference application 42 to generate a combined image 105 such that the panoramic image 203 and the talker image 204 are arranged on the left side and the application screen 103 is arranged on the right side. The application screen is an example of screen information (described later) based on which a screen of each application such as a teleconference application is displayed. Since the processing of (3) is repeatedly executed, the combined image 105 is a moving image (hereinafter referred to as a composite moving image). Further, the information recording application 41 attaches the synthesized audio data to the composite moving image to generate a moving image with audio.

In the present embodiment, an example is described in which the panoramic image 203, the talker image 204, and the application screen 103 are combined. In another example, the information recording application 41 may store these images separately and arrange these images on a screen at the time of replay.

(4) The information recording application 41 receives an editing operation such as cutting off of unnecessary parts by the user and completes the composite moving image. The composite moving image forms a part of the record of conference.

(5) The information recording application 41 transmits the generated composite moving image (with the audio) to a storage service system 70 to be stored.

(6) Further, the information recording application 41 extracts only the audio data from the composite moving image (or may use the audio data before being synthesized) and transmits the extracted audio data to an information processing system 50. The information processing system 50 transmits the audio data to a speech recognition service system 80 that converts the audio data into text data. The text data includes data representing an elapsed time from a start of recording when the audio is generated. That is, the text data includes data indicating how many minutes have elapsed from a start of recording until utterance.

In a case where text conversion is performed in real time, the meeting device 60 directly transmits the audio data to the information processing system 50. In such a case, the information processing system 50 transmits text data converted from the audio data to the information recording application 41 in real time.

(7) The information processing system 50 transmits the text data to the storage service system 70 to be stored in addition to the composite moving image. The text data forms a part of the record of conference.

Note that the information processing system 50 has a function to execute processing of charging the user for the service used by the user. For example, a charging fee is calculated based on an amount of the text data, a file size of the composite moving image, or processing time.

As described above, in the composite moving image, a panoramic image including the user and the talker image are displayed and also a screen of an application displayed in the teleconference, such as the teleconference application 42, is displayed. When a participant of the teleconference or a person who has not participated in the teleconference views the composite moving image as the minutes, scenes in the teleconference are reproduced with a sense of presence.

Outline of Processing of Muting

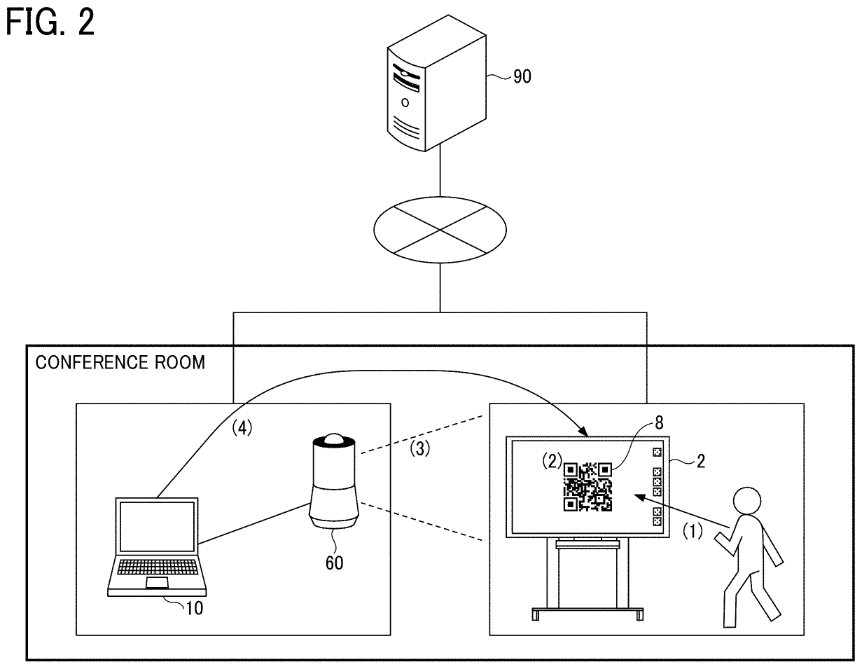

A description is now given of processing executed by the terminal apparatus 10 to mute the electronic whiteboard 2 with reference to FIG. 2. FIG. 2 is a schematic diagram illustrating processing executed by the terminal apparatus 10 to mute a microphone and a speaker of the electronic whiteboard 2 according to the present embodiment. The meeting device 60 and the electronic whiteboard 2 each have a microphone and a speaker. Audio output from the meeting device 60 is received by the microphone of the electronic whiteboard 2. The electronic whiteboard 2 transmits the audio (data) to the teleconference service system 90. The teleconference service system 90 transmits the audio to the terminal apparatus 10. The terminal apparatus 10 transmits the audio to the meeting device 60 to output the audio. When this cycle is repeated, howling may occur. Conversely, audio output from the electronic whiteboard 2 is received by the microphone of the meeting device 60. The meeting device 60 transmits the audio (data) to the terminal apparatus 10 to be transmitted to the teleconference service system 90. The teleconference service system 90 transmits the audio to the electronic whiteboard 2. The electronic whiteboard 2 outputs the audio. When this cycle is repeated, howling may occur.

For this reason, the meeting device 60 according to the present embodiment eliminates or reduces the bowling as follows.

(1) The user performs an operation to instruct the electronic whiteboard 2 to participate in a conference.

(2) The electronic whiteboard 2 displays a two-dimensional code 8 such as a QUICK RESPONSE (QR) CODE. The two-dimensional code 8 includes information relating to the electronic whiteboard 2, such as an internet protocol (IP) address and a device identifier of the electronic whiteboard 2.

(3) The meeting device 60 captures an image of the two-dimensional code 8 and decodes the two-dimensional code 8 to acquire the IP address and the device identifier of the electronic whiteboard 2.

(4) The terminal apparatus 10 calls an Application Programming Interface (API) of the electronic whiteboard 2 with the IP address as a destination and requests the electronic whiteboard 2 to be muted. Alternatively, the terminal apparatus 10 may request the electronic whiteboard 2 to be muted via the information processing system 50 by designating the device identifier of the electronic whiteboard 2.

As described above, since the meeting device 60 according to the present embodiment requests the electronic whiteboard 2 displaying the two-dimensional code to be muted, an appropriate device is muted without a mistake. In addition, in a case where the user desires the meeting device 60 located at the center of the participants in the conference to output audio and the microphone of the electronic whiteboard 2 for receiving audio to be muted, such control cannot be performed in the conventional technology. In the present embodiment, the device is not mistaken as described above.

### Terminology

Adjustment of audio volume (to adjust audio volume) refers primally to reducing audio volume. A method for adjusting audio volume is to adjust volume of at least one of audio to be received by a microphone and audio to be output from a speaker. An example of adjusting audio volume is muting. Adjustment of audio volume may include controlling audio volume so low that a microphone cannot detect the audio volume. In the present embodiment, adjustment of audio volume is simply described by the term “mute (muting).”

A device for inputting information may be any device that inputs an image, audio, or a radio wave, such as a camera (an imaging device), a microphone, or a device that can perform short-range wireless communication.

A device for outputting information may be any device that displays an image such as a display, or any other device that outputs audio or a radio wave such as a speaker or a device that can perform short-range wireless communication.

A first apparatus is an apparatus that processes information relating to communication, and is described by the term “the meeting device 60” in this embodiment. The first apparatus preferably includes an imaging device for capturing an image of surroundings, a microphone for receiving audio, and a receiver for receiving a beacon. In addition, the first apparatus may include a speaker.

A second apparatus is any apparatus that displays information. The second apparatus is described by the term “the electronic whiteboard 2” in this embodiment. The electronic whiteboard may also be referred to as, for example, an electronic information board or an interactive board. A projector is known as a device equivalent to the electronic whiteboard 2. Alternatively, the second apparatus may be a digital signage, a television, a display, a multifunction peripheral, a video conference terminal, or the like in other embodiments.

Information relating to the second apparatus is information used for identifying the second apparatus in communication with the second apparatus. Examples of the information relating to the second apparatus are a device identifier and an IP address of the second apparatus. The information relating to the second apparatus may include information indicating whether the electronic whiteboard is currently in a mute state. The two-dimensional code 8 is an example of visible information on the second apparatus.

Image information of surroundings around the meeting device acquired by the meeting device refers to image information acquired by the meeting device capturing an image of a surrounding space (for example, 180 to 360 degrees in the horizontal direction) around the meeting device. The image information of surroundings around the meeting device refers to an image obtained by performing predetermined processing on image information of a curved-surface image captured by the meeting device. Examples of the predetermined processing include various types of processing for generating, from information captured by the meeting device, the image information of the surroundings, such as flattening processing on the captured image of the curved surface. Examples of the predetermined processing may further include processing of cutting out an image of a talker and processing of combining the image of the surroundings and the talker image, in addition to the processing for generating the image information of the surroundings. In the present embodiment, the image of the surroundings is described with the term “panoramic image.” The panoramic image is an image having an angle of view of substantially 180 to 360 degrees in the horizontal direction. The panoramic image is not necessarily captured by a single meeting device, and may be captured by a combination of a plurality of imaging devices each having an ordinary angle of view. In the present embodiment, the meeting device is assumed to be placed and used on a table or other place for holding a teleconference at a site or for grasping a situation of surroundings. Alternatively, a device used for monitoring (security, disaster prevention, etc.), watching (childcare, nursing, etc.), or analyzing a situation of a site (solutions, marketing, etc.) may be used as the meeting device.

The term “record of conference” refers to information recorded by the information recording application 41. The record of conference is stored in a viewable manner in association with identification information of a certain conference (meeting). Examples of the record of conference are as follows:
moving image data generated based on screen information displayed by a selected application (e.g., a teleconference application) and image information of surroundings around the device acquired by the device;
audio data acquired and synthesized by the teleconference application (the terminal apparatus) and the meeting device located at a site in a conference (meeting);
text data obtained by converting the acquired audio data; and
any data or image, which is information relating to a conference (meeting).

Examples of any data or image include, but are not limited to, a document file used in the conference, an added memo, translation data obtained by translating text data, and images and stroke data generated by an electronic whiteboard in a cloud service in the conference. In a case where the information recording application 41 records screens of the teleconference application or situations of the conference held at the site, the record of conference is sometimes used as minutes of the held conference. The minutes are merely examples of the record of conference. The name of the record of conference may vary depending on contents of the teleconference or contents carried out at the site, and may be referred to as a record of communication or a record of situation at a site, for example. Further, the record of conference includes files of a plurality of formats such as a moving image file (a composite moving image or the like), an audio file, a text data (text data obtained by performing speech recognition on audio) file, a document file, an image file, and a tabular form file. Each of the files and identification information of the conference are associated with each other. Thus, when the files are viewed, the files are collectively or selectively viewable in time series.

The term “tenant” refers to a group of users such as a company, a municipality, or a part of such organizations that has a contract to receive a service from a service provider. In the present embodiment, creation of the record of conference and conversion into the text data are performed since the tenant has a contract with a service provider.

The term “remote communication” refers to communication with audio and video by using software and a terminal apparatus with a counterpart at a physically remote site. An example of the remote communication is a teleconference. A conference may be referred to as a meeting, a session, a discussion, a consultation, an application for a contract, a gathering, a get-together, a seminar, a lecture, a study meeting, a study session, or a workshop.

The term “site” refers to a place where an activity is performed. An example of the site is a conference room. The conference room is a room set up to be used primarily for a conference. Other examples of the site are a home, a reception desk, a store, a warehouse, an outdoor site, and any other place or space where a terminal apparatus or a device can be installed.

The term “audio” refers to an utterance made by a person, ambient sound, or the like. The term “audio data” refers to data obtained by converting the audio. In the description of the present embodiment, the audio and the audio data are not strictly distinguished from each other.

System Configuration

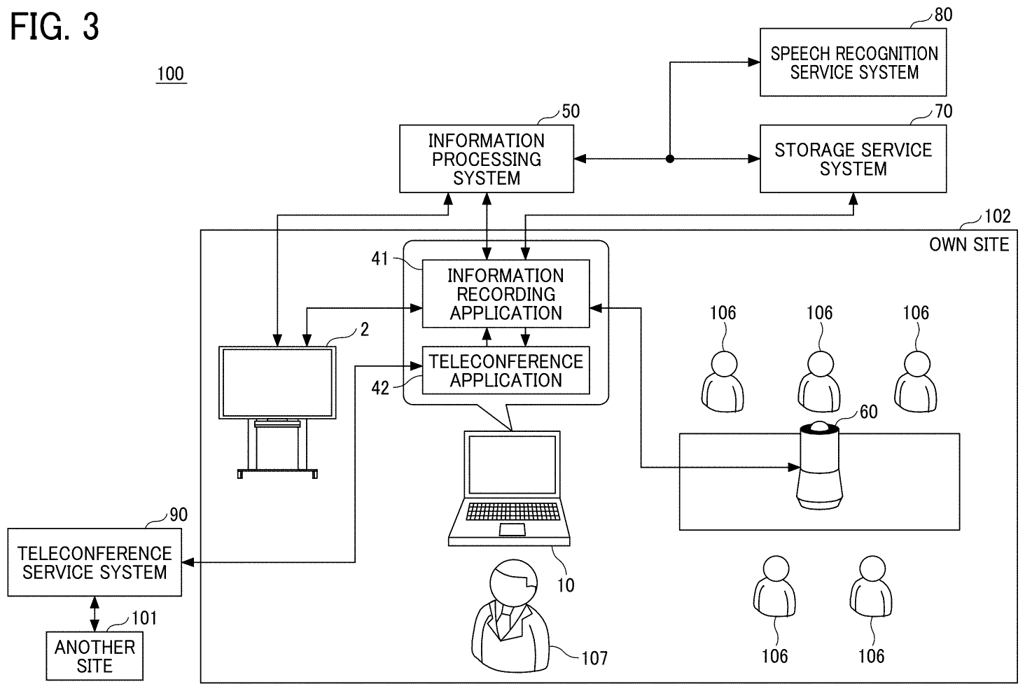

A description is now given of a system configuration of the information recording system 100 according to the present embodiment with reference to FIG. 3. FIG. 3 is a schematic diagram illustrating an example of a configuration of the information recording system 100 according to the present embodiment. In FIG. 3, one site (the own site 102) among a plurality of sites participating in a teleconference is illustrated. The terminal apparatus 10 located at the own site 102 communicates with the information processing system 50, the storage service system 70, and the teleconference service system 90 via a network. In addition, the meeting device 60 and the electronic whiteboard 2 are placed in the own site 102. The terminal apparatus 10 is communicably connected to the meeting device 60 via a universal serial bus (USB) cable or the like. The meeting device 60 and the electronic whiteboard 2, or the meeting device 60, the electronic whiteboard 2, and the information processing system 50 operate as an information processing system.

On the terminal apparatus 10, at least the information recording application 41 and the teleconference application 42 operate. The teleconference application 42 communicates with another terminal apparatus located at the other site 101 via the teleconference service system 90 residing on the network. Thus, users at each remote site can participate in the teleconference. The information recording application 41 uses functions of the information processing system 50 and the meeting device 60 to create a record of conference of the teleconference performed by the teleconference application 42.

In the present embodiment, a description is given of an example in which a record of conference of a teleconference is created. However, in another example, the conference is not necessarily held among remote sites. In other words, the conference may be a conference in which participants at a single site participate. In this case, the image captured by the meeting device 60 and the audio received by the meeting device 60 are independently stored without being combined. The rest of the processing performed by the information recording application 41 remains unchanged.

The terminal apparatus 10 includes a built-in (or external) camera having an ordinary angle of view. The camera included in the terminal apparatus 10 captures an image of a front space including a user 107 who operates the terminal apparatus 10. Such a camera having an ordinary angle of view captures an image that is not a panoramic image. In the present embodiment, the built-in camera having the ordinary angle of view primarily captures a planar image that is not curved such as a spherical image. Thus, the user can participate in a teleconference using the teleconference application 42 as usual without paying attention to the information recording application 41. The information recording application 41 and the meeting device 60 do not affect the teleconference application 42 except for an increase in the processing load on the terminal apparatus 10. The teleconference application 42 can transmit a panoramic image or a talker image captured by the meeting device 60 to the teleconference service system 90.

The information recording application 41 communicates with the meeting device 60 to create a record of conference. The information recording application 41 also synthesizes audio received by the meeting device 60 and audio received by the teleconference application 42 from another site. The meeting device 60 is a device for a conference, including an imaging device that can capture a panoramic image, a microphone, and a speaker. The camera included in the terminal apparatus 10 captures an image of only a limited range of the front space. In contrast, the meeting device 60 captures an image of the entire surroundings (not necessarily the entire surroundings) around the meeting device 60. The meeting device 60 can keep a plurality of participants 106 illustrated in FIG. 3 within the angle of view at all times.

In addition, the meeting device 60 cuts out a talker image from a panoramic image. The meeting device 60 is placed on a table in FIG. 3, but may be placed anywhere in the own site 102. Since the meeting device 60 can capture a spherical image, the meeting device 60 may be disposed, for example, on a ceiling.

The information recording application 41 displays a list of applications operating on the terminal apparatus 10, combines images for creating the above-described record of conference (generates a composite moving image), reproduces the composite moving image, and receives editing. Further, the information recording application 41 displays a list of teleconferences already held or to be held in the future. The list of teleconferences is used in information relating to the record of conference for allowing the user to link a teleconference with the record of conference.

The teleconference application 42 is an application that enables a terminal apparatus to perform a remote communication with the other terminal apparatus located at the other site 101 by establishing a connection to and communicating with the other terminal apparatus, transmitting and receiving an image and audio, and displaying the image and outputting the audio. The teleconference application may also be referred to as a remote communication application, a remote information sharing application, and the like.

Each of the information recording application 41 and the teleconference application 42 is either a web application or a native application. The web application is an application in which a program on a web server and a program on a web browser or a native application cooperate with each other to perform processing. The web application does not need to be installed in the terminal apparatus 10. The native application is an application that is installed in the terminal apparatus 10 for use. In the present embodiment, both the information recording application 41 and the teleconference application 42 are assumed to be native applications.

The terminal apparatus 10 is, for example, a general-purpose information processing apparatus having a communication function, such as a personal computer (PC), a smartphone, or a tablet terminal. Additionally, the terminal apparatus 10 is, for example, an electronic whiteboard, a game console, a personal digital assistant (PDA), a wearable PC, a car navigation system, an industrial machine, a medical device, or a networked home appliance. Any apparatus on which at least the information recording application 41 and the teleconference application 42 operate is used as the terminal apparatus 10.

The electronic whiteboard 2 displays data handwritten on a touch panel with an input device such as a pen or a finger on a display. The electronic whiteboard 2 communicates with the terminal apparatus 10 by wired or wireless communication, and can capture a screen displayed by the terminal apparatus 10 to display the captured screen on the display. The electronic whiteboard 2 can convert handwritten data into text data, and can share information displayed on the display with another electronic whiteboard located at another site. The electronic whiteboard 2 may be a simple whiteboard not including a touch panel, onto which a projector projects an image. The electronic whiteboard 2 is, for example, a tablet terminal including a touch panel, a notebook PC, a PDA, or a game console.

The electronic whiteboard 2 communicates with the information processing system 50. The electronic whiteboard 2 receives information from the information processing system 50, for example, by polling the information processing system 50 or by using bidirectional communication such as WebSocket after the electronic whiteboard 2 is turned on.

The information processing system 50 includes one or more information processing apparatuses residing on a network. The information processing system 50 includes at least one server application that performs processing in cooperation with the information recording application 41, and provides basic services. The server application manages a list of teleconferences, a record of conference recorded in a teleconference, various settings, and path information of storages. Examples of the basic services are user authentication, processing of contracting, and processing of charging. Thus, the information processing system may be referred to as an information processing server.

All or some of the functions of the information processing system 50 reside either in a cloud environment or in an on-premises environment. The information processing system 50 may be implemented by a plurality of server computers or may be implemented by a single information processing apparatus. For example, the server application and the basic services may be respectively provided by different information processing apparatuses. Further, for example, the functions of the sever application may be provided by respective information processing apparatuses. The information processing system 50 may be integral with the storage service system 70 and the speech recognition service system 80 to be described below.

The storage service system 70 is a storage on a network and provides a storage service for storing files and the like. MICROSOFT ONEDRIVE, GOOGLE WORKSPACE, DROPBOX, and the like are known as storage service systems. The storage service system 70 is, for example, a Network Attached Storage (NAS) in an on-premises environment.

The speech recognition service system 80 provides a service for converting audio data into text data by performing speech recognition on the audio data. The speech recognition service system 80 is, for example, either a general commercial service or a part of the functions of the information processing system 50. The service system set for and used as the speech recognition service system 80 may be different for each user, each tenant, or each conference.

Hardware Configuration

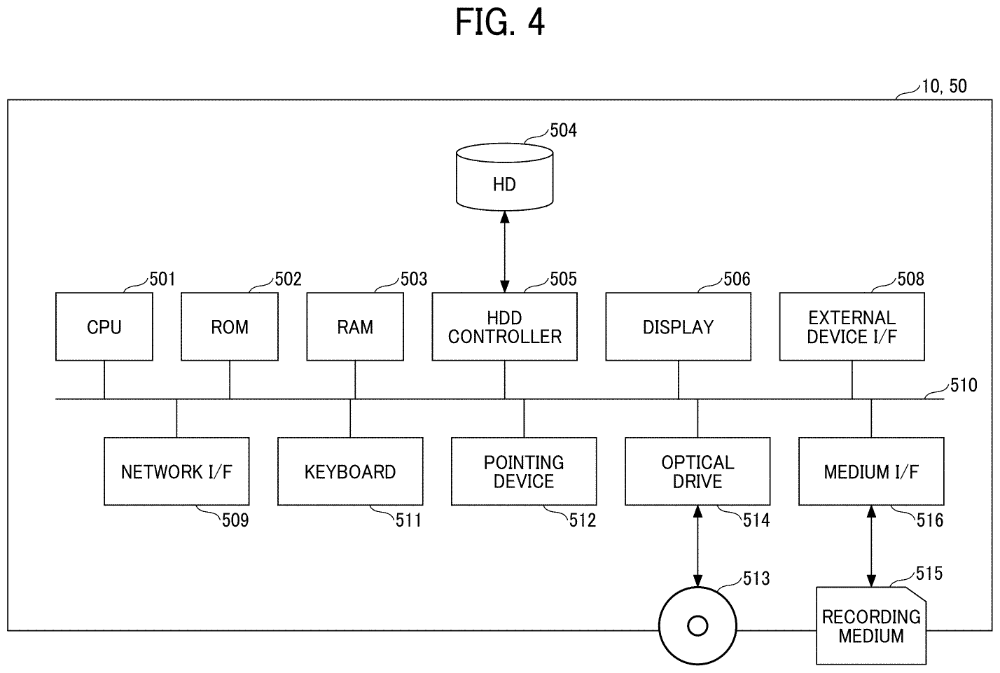

A description is given of a hardware configuration of the information processing system 50 and the terminal apparatus 10 according to the present embodiment with reference to FIG. 4.

Information Processing System and Terminal Apparatus

FIG. 4 is a block diagram illustrating an example of a hardware configuration of the information processing system 50 and the terminal apparatus 10 according to the present embodiment. As illustrated in FIG. 4, each of the information processing system 50 and the terminal apparatus 10 is implemented by a computer. The computer includes a central processing unit (CPU) 501, a read only memory (ROM) 502, a random access memory (RAM) 503, a hard disk (HD) 504, a hard disk drive (HDD) controller 505, a display 506, an external device interface (I/F) 508, a network I/F 509, a bus line 510, a keyboard 511, a pointing device 512, an optical drive 514, and a medium I/F 516.

The CPU 501 controls entire operation of one of the information processing system 50 and the terminal apparatus 10 to which the CPU 501 belongs. The ROM 502 stores a program such as an initial program loader (IPL) used for driving the CPU 501. The RAM 503 is used as a work area for the CPU 501. The HD 504 stores various data such as a control program. The HDD controller 505 controls reading and writing of various data from and to the HD 504 under control of the CPU 501. The display 506 displays various types of information such as a cursor, a menu, a window, characters, and images. The external device I/F 508 is an interface for connection with various external devices. Examples of the external devices include, but not limited to, a USB memory and a printer. The network I/F 509 is an interface for data communication through a communication network. The bus line 510 is an address bus or a data bus, which electrically connects each component illustrated in FIG. 4 such as the CPU 501.

The keyboard 511 is an example of an input device including a plurality of keys for inputting characters, numerical values, various instructions, and the like. The pointing device 512 is an example of an input device that allows a user to select or execute various instructions, select an object for processing, and move a cursor being displayed. The optical drive 514 controls reading and writing of various data from and to an optical recording medium 513, which is an example of a removable recording medium. The optical recording medium 513 may be a compact disc (CD), a digital versatile disc (DVD), BLU-RAY disc, or the like. The medium I/F 516 controls reading and writing (storing) of data from and to a recording medium 515 such as a flash memory.

Meeting Device

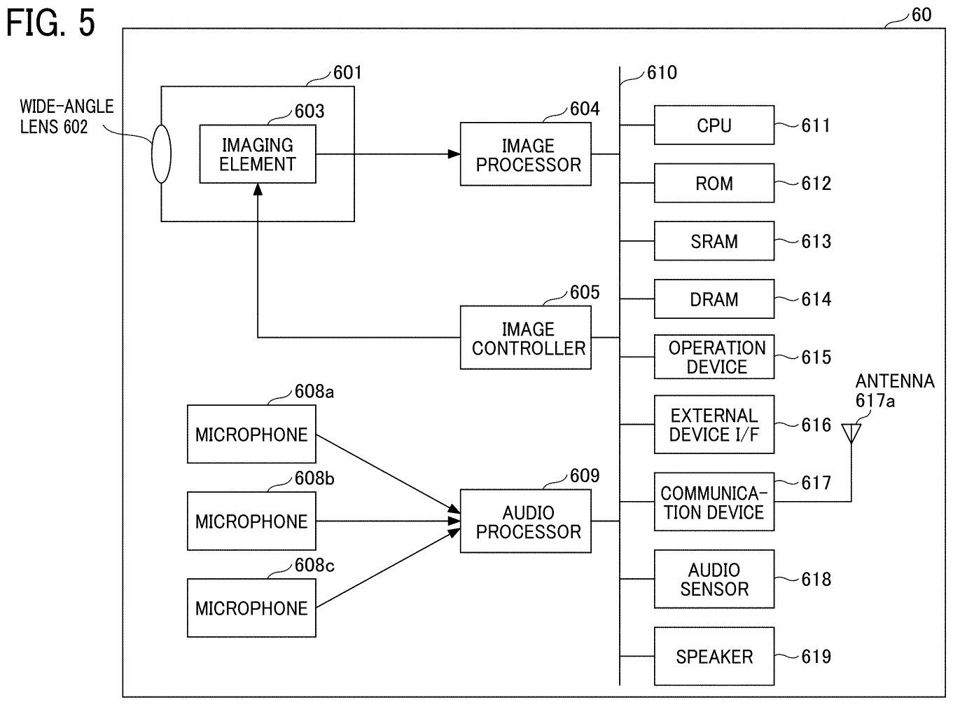

A description is now given of a hardware configuration of the meeting device 60 with reference to FIG. 5. FIG. 5 is a block diagram illustrating an example of a hardware configuration of the meeting device 60 that can capture a moving image of surroundings in 360 degrees, according to the present embodiment. In the following description, the meeting device 60 is assumed to be a device that uses an imaging element to capture the moving image of surroundings in 360 degrees around the device at a predetermined height. The number of imaging elements may be one or two or more. The meeting device 60 is not necessarily a dedicated device. In another example, an external imaging unit that can capture a moving image of surroundings in 360 degrees may be retrofitted to a PC, a digital camera, or a smartphone to implement a meeting device having substantially the same functions as those of the meeting device 60.

As illustrated in FIG. 5, the meeting device 60 includes an imaging device 601, an image processor 604, an imaging controller 605, microphones 608a to 608c, an audio processor 609, a CPU 611, a ROM 612, a static random access memory (SRAM) 613, a dynamic random access memory (DRAM) 614, an operation device 615, an external device IF 616, a communication device 617, an antenna 617a, an audio sensor 618, and a speaker 619.

The imaging device 601 includes a wide-angle lens (so-called a fish-eye lens) 602 having an angle of view of 360 degrees so as to form a hemispherical image, and an imaging element 603 (an image sensor) corresponding to the wide-angle lens 602. The imaging element 603 includes an imaging sensor such as a complementary metal oxide semiconductor (CMOS) sensor or a charge-coupled device (CCD) sensor, a timing generation circuit, and a group of registers. The imaging sensor converts an optical image formed by the wide-angle lens 602 into electric signals to output image data. The timing generation circuit generates horizontal or vertical synchronization signals, pixel clocks, and the like for the imaging sensor. Various commands, parameters, and the like for operations of the imaging element 603 are set in the group of registers. The imaging device 601 is, for example, a 360-degree camera. The imaging device 601 is an example of an imaging device that can capture a moving image of surroundings in 360 degrees around the meeting device 60.

The imaging element 603 (image sensor) of the imaging device 601 is connected to the image processor 604 via a parallel I/F bus. In addition, the imaging elements 603 of the imaging device 601 is connected to the imaging controller 605 via a serial I/F bus such as an inter-integrated circuit (I2C) bus or the like. Each of the image processor 604, the imaging controller 605, and the audio processor 609 may be implemented by a circuit and is connected to the CPU 611 via a bus 610. The ROM 612, the SRAM 613, the DRAM 614, the operation device 615, the external device/F 616, the communication device 617, the audio sensor 618, and the speaker 619 are also connected to the CPU 611 via the bus 610.

The image processor 604 acquires image data output from the imaging element 603 via the parallel I/F bus, and performs predetermined processing on the acquired image data to generate data of a panoramic image and a talker image from an image captured by the wide-angle lens. The image processor 604 combines the panoramic image and the talker image to output a single moving image.

The imaging controller 605 usually functions as a master device while the imaging element 603 usually functions as a slave device. The imaging controller 605 sets commands and the like in the group of registers of the imaging element 603 via the I2C bus. The imaging controller 605 receives various commands from the CPU 611. In addition, the image controller 605 acquires status data of the group of registers of the imaging element 603 via the I2C bus and transmits the status data to the CPU 611.

Further, the imaging controller 605 instructs the imaging element 603 to output image data at a timing when an imaging start button of the operation device 615 is pressed or at a timing when an instruction to start imaging is received from the PC. In some cases, the meeting device 60 has functions that support a preview display function and a moving image display function to be implemented by a display (e.g., a display of a PC or a smartphone). As for the moving image display function, image data are continuously output from the imaging element 603 at a predetermined frame rate (frames per second).

Furthermore, as will be described later, the imaging controller 605 operates in cooperation with the CPU 611 to synchronize the time when the imaging element 603 outputs the image data. In the present embodiment, the meeting device 60 does not include a display. However, in another embodiment, the meeting device 60 may include a display.

Each of the microphones 608a to 608c converts audio into audio (signal) data. The audio processor 609 acquires audio data output from each of the microphones 608a to 608c via an I/F bus, and mixes the audio data output from each of the microphones 608a to 608c to perform predetermined processing. The audio processor 609 also determines a direction of an audio source (talker) from a level of the audio (volume) input from each of the microphones 608a to 608c.

The speaker 619 converts input audio data into audio. The microphones 608a to 608c and the speaker 619 are examples of an input and output device. The input and output device does not necessarily have to be integrated into one device. In another example, an input device and an output device may be separately provided.

The CPU 611 controls entire operation of the meeting device 60 and executes necessary processing. The ROM 612 stores various programs for operating the meeting device 60. The SRAM 613 and the DRAM 614 each work as a work memory and store programs to be executed by the CPU 611, data that is being processed, and the like. In particular, the DRAM 614 stores image data that is being processed by the image processor 604 and data of an equirectangular projection image on which processing has been performed.

The operation device 615 collectively refers to various operation keys, such as the imaging start button. The user operates the operation device 615 to start capturing an image and recording. In addition, the user operates the operation device 615 to turn on or off the meeting device 60, to establish a connection for communication, and to input settings such as various imaging modes and imaging conditions.

The external device I/F 616 is an interface for connection with various external devices. Examples of the external devices include, but not limited to, a PC, a display, a projector, and an electronic whiteboard. The external device I/F 616 may include, for example, a USB terminal or a High-Definition Multimedia Interface (HDMI) terminal. Moving image data and image data stored in the DRAM 614 are transmitted to an external terminal or recorded in an external recording medium via the external device I/F 616. Further, a plurality of external device I/Fs 616 may be used. In this case, while image data captured by the meeting device 60 is transmitted to a PC via USB and recorded by the PC, an image (for example, screen information representing a screen to be displayed by a teleconference application) acquired from the PC may be transmitted to the meeting device 60, and further transmitted from the meeting device 60 to another external device (a display, a projector, an electronic whiteboard, etc.) via the HDMI terminal to be displayed.

The terminal communication unit 617 is implemented by, for example, a network interface circuit. The communication device 617 may communicate with a cloud server via the Internet using a wireless communication technology such as Wireless Fidelity (Wi-Fi) via an antenna 617a included in the meeting device 60 and transmit the moving image data and the image data stored in the DRAM 614 to the cloud server. Further, the communication device 617 may be able to communicate with nearby devices using a short-range wireless communication technology such as BLUETOOTH LOW ENERGY (BLE) or the near field communication (NFC).

The audio sensor 618 is a sensor that acquires audio data in 360 degrees in order to specify the direction from which audio of high volume is input in the surroundings in 360 degrees (on a horizontal plane) around the meeting device 60. The audio processor 609 determines a direction in which the audio of the highest volume is input in the surroundings in 360 degrees based on a 360-degree audio parameter input in advance, and outputs the audio input from the determined direction.

Note that another sensor such as an azimuth and acceleration sensor or a global positioning system (GPS) sensor may be used to calculate an azimuth, a position, an angle, an acceleration, and the like for image correction or addition of position information.

The CPU 611 generates a panoramic image in the following method. The CPU 611 performs predetermined camera image processing such as Bayer interpolation (red green blue (RGB) supplementation processing) on raw data input by an image sensor that inputs a spherical image to generate a wide-angle image (a moving image including curved-surface images). Further, the CPU 611 performs unwrapping processing (distortion correction processing) on the wide-angle image (the moving image including curved-surface images) to generate a panoramic image (a moving image including planar images) of the surroundings in 360 degrees around the meeting device 60.

The CPU 611 generates a talker image in the following method. The CPU 611 generates a talker image on which a talker is cut out from a panoramic image (a moving image including planar images) of the surroundings in 360 degrees around the meeting device 60. The CPU 611 determines a direction of the input audio identified from the audio of the surroundings in 360 degrees using the audio sensor 618 and the audio processor 609 to be a direction of the talker, and cuts out a talker image from the panoramic image. At this time, a method of cutting out an image of a person based on the direction of the input audio includes cutting out an image of, from 360 degrees, 30 degrees centered around the determined direction of the input audio and performing processing to detect a human face on the image of 30 degrees. Thus, the image of the person is cut out. The CPU 611 further identifies talker images of a specific number of persons (e.g., three persons) who have most recently spoken among cut out talker images.

The panoramic image and the one or more talker images are individually transmitted to the information recording application 41. Alternatively, the meeting device 60 may generate a single image from the panoramic image and the one or more talker images to be transmitted to the information recording application 41. In the present embodiment, it is assumed that the panoramic image and the one or more talker images are individually transmitted from the meeting device 60 to the information recording application 41.

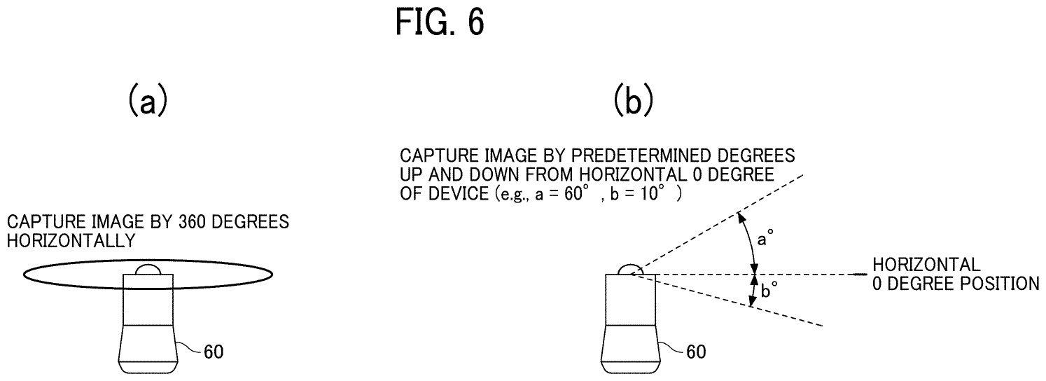

FIG. 6 is a schematic diagram illustrating an imaging range of the meeting device 60 according to the present embodiment. As illustrated in part (a) of FIG. 6, the meeting device 60 captures an image of a range of 360 degrees in the horizontal direction. As illustrated in part (b) of FIG. 6, the meeting device 60 captures an image in predetermined angles up and down from a 0-degree direction that is horizontal to the height of the meeting device 60.

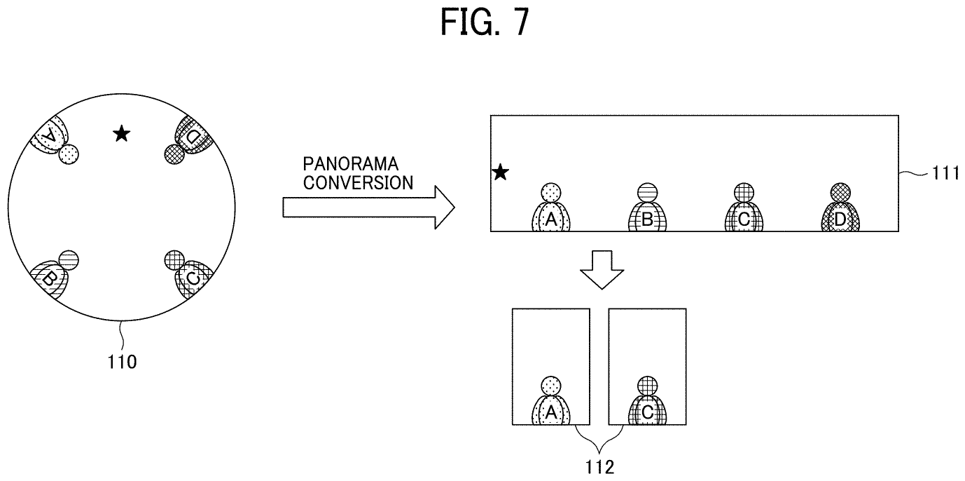

FIG. 7 is a schematic diagram illustrating a panoramic image and processing to cut out talker images from the panoramic image according to the present embodiment. As illustrated in FIG. 7, since an image captured by the meeting device 60 forms a part of a sphere 110, the image has a three-dimensional shape. As illustrated in part (b) of FIG. 6, the meeting device 60 divides angles of view into the predetermined degrees up and down and by the predetermined angle in the horizontal direction to perform perspective projection conversion on each of the angles of view. A predetermined number of planar images are obtained by performing the perspective projection conversion on the entire 360-degree range in the horizontal direction without gaps. Thus, a panoramic image 111 is obtained by laterally connecting the predetermined number of planar images. Further, the meeting device 60 performs the processing to detect a human face in a predetermined range centered around the direction of audio in the panoramic image, and generates talker images 112 by cutting out images by 15 degrees each (30 degrees in total) to the left and right from the center of the human face.

Electronic Whiteboard

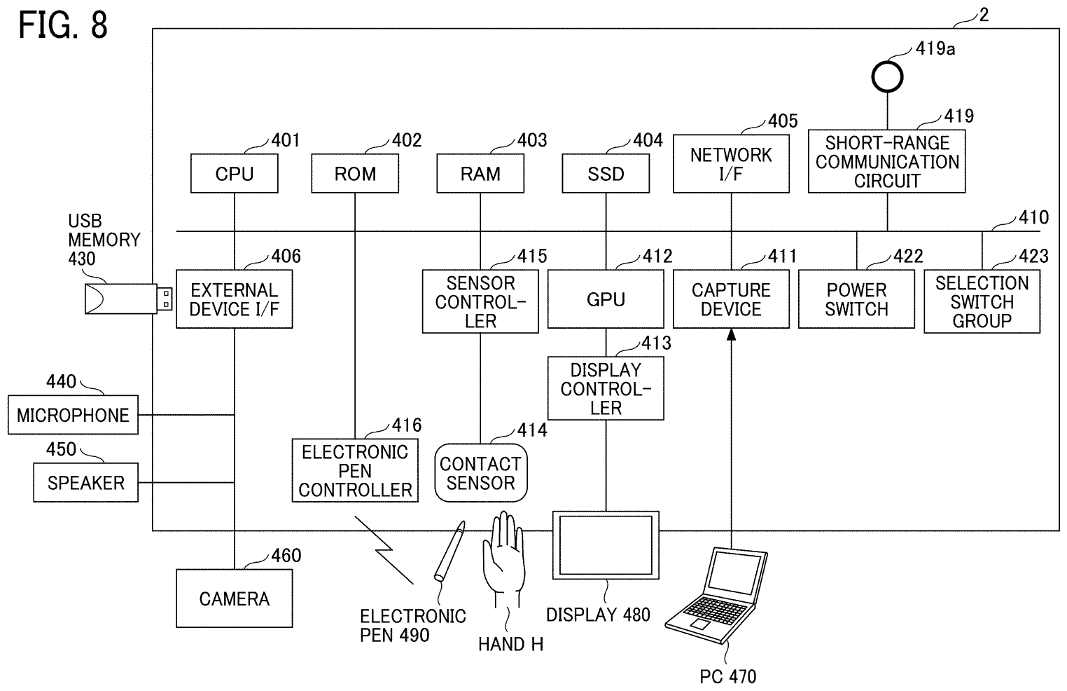

FIG. 8 is a block diagram illustrating a hardware configuration of the electronic whiteboard 2 according to the present embodiment. As illustrated in FIG. 8, the electronic whiteboard 2 includes a CPU 401, a ROM 402, a RAM 403, a solid state drive (SSD) 404, a network I/F 405, and an external device I/F 406.

The CPU 401 controls overall operation of the electronic whiteboard 2. The ROM 402 stores a program such as an IPL to boot an operating system (OS). The RAM 403 is used as a work area for the CPU 401. The SSD 404 stores various data such as a control program for the electronic whiteboard 2. The network I/F 405 controls communication with external devices through a communication network. The external device I/F 406 is an interface for connection with various external devices. Examples of the external devices include, but are not limited to, a USB memory 430 and external devices such as a microphone 440 (an example of an input device), a speaker 450 (an example of an output device), and a camera 460.

The electronic whiteboard 2 includes a capture device 411, a graphics processing unit (GPU) 412, a display controller 413, a contact sensor 414, a sensor controller 415, an electronic pen controller 416, a short-range communication circuit 419, an antenna 419a of the short-range communication circuit 419, a power switch 422, and a selection switch group 423.

The capture device 411 causes a display of an external PC 470 to display a still image or a moving image based on image data captured by the capturing device. The GPU 412 is a semiconductor chip dedicated to processing of a graphical image. The display controller 413 controls display of an image processed by the GPU 412 to output to a display 480. The contact sensor 414 detects a touch onto the display 480 with an electronic pen 490 or a user's hand H. The sensor controller 415 controls processing performed by the contact sensor 414. The contact sensor 414 inputs and detects coordinates by using an infrared blocking system. More specifically, for inputting and detecting the coordinates, the display 480 is provided with two light receiving and emitting devices disposed on both upper side ends of the display 480, and a reflector frame surrounding the sides of the display 480. The light receiving and emitting devices emit a plurality of infrared rays in parallel to a surface of the display 480. Light-receiving elements receive lights passing in the direction that is the same as an optical path of the emitted infrared rays, which are reflected by the reflector frame. The contact sensor 414 outputs, to the sensor controller 415, position information (a position on the light-receiving elements) of an infrared ray that is blocked by an object after being emitted from the two light receiving and emitting devices. Based on the position information of the infrared ray, the sensor controller 415 detects specific coordinates that are touched by the object. The electronic pen controller 416 communicates with the electronic pen 490 by BLUETOOTH to detect a touch by the tip or bottom of the electronic pen 490 to the display 480. The short-range communication circuit 419 is a communication circuit in compliance with the NFC, BLUETOOTH, or the like. The power switch 422 turns on or off the power of the electronic whiteboard 2. The selection switch group 423 is a group of switches for adjusting brightness, hue, etc., of display on the display 480, for example.

The electronic whiteboard 2 further includes a bus line 410. The bus line 410 is an address bus or a data bus, which electrically connects each component illustrated in FIG. 8 such as the CPU 401.

Note that the contact sensor 414 is not limited to a sensor using the infrared blocking system, but may be, for example, a capacitive touch panel that identifies a contact position by detecting a change in capacitance. Alternatively, the contact sensor 414 may be a resistance film touch panel that identifies a contact position by a change in voltage of two opposing resistance films. Further, the contact sensor 414 may be an electromagnetic induction touch panel that identifies a contact position by detecting electromagnetic induction caused by contact of an object to the display. In addition to the devices described above, various types of detection devices may be used as the contact sensor 414. In addition to or alternative to detecting a touch by the tip or bottom of the electronic pen 490, the electronic pen controller 416 may also detect a touch by another part of the electronic pen 490, such as a part held by a hand of a user.

Functions

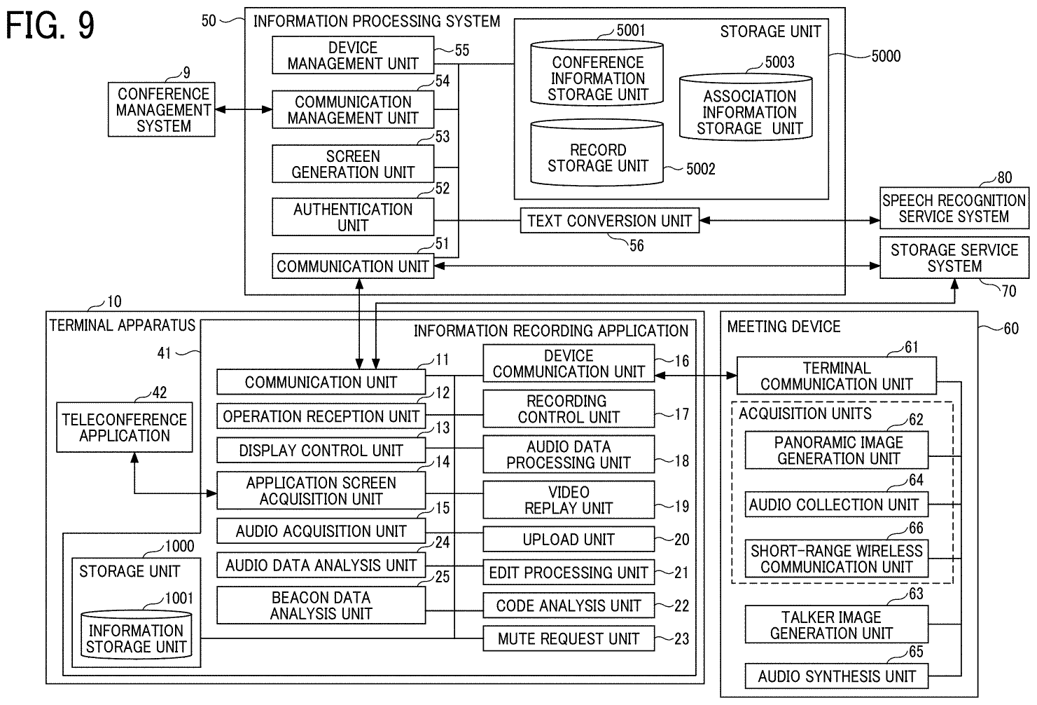

A description is now given of a functional configuration of the information recording system 100 according to the present embodiment with reference to FIG. 9. FIG. 9 is a block diagram illustrating functional configurations of the terminal apparatus 10, the meeting device 60, and the information processing system 50 in the information recording system 100 according to the present embodiment.

Terminal Apparatus

The information recording application 41 that operates on the terminal apparatus 10 implements a communication unit 11, an operation reception unit 12, a display control unit 13, an application screen acquisition unit 14, an audio acquisition unit 15, a device communication unit 16, a recording control unit 17, an audio data processing unit 18, a video replay unit 19, an upload unit 20, an edit processing unit 21, a code analysis unit 22, a mute request unit 23, an audio data analysis unit 24, and a beacon data analysis unit 25. These units of functions included in the terminal apparatus 10 are implemented by or caused to function by one or more of the hardware components illustrated in FIG. 4 operating in accordance with instructions from the CPU 501 according to the information recording application 41 loaded from the HD 504 to the RAM 503. The terminal apparatus 10 further includes a storage unit 1000 implemented by the HD 504 illustrated in FIG. 4. The storage unit 1000 includes an information storage unit 1001, which is implemented by a database.

The communication unit 11 transmits and receives various types of information to and from the information processing system 50 via a communication network. The operation reception unit 12 receives various operations for the information recording application 41. The display control unit 13 control display of various screens serving as user interfaces in the information recording application 41 in accordance with screen transitions set in the information recording application 41.

The application screen acquisition unit 14 acquires screen information based on which a screen is displayed by an application selected by the user or screen information of a desktop screen from the OS or the like. In a case where the application selected by the user is the teleconference application 42, the application screen acquisition unit 14 acquires a screen generated by the teleconference application 42. The screen generated by the teleconference application 42 includes images of users using terminal apparatuses at each site, which are captured by cameras of the terminal apparatuses, a screen image of a shared material, images of icons of participants, and images of names of the participants. The screen information (application screen) displayed by the application is information displayed as a window by an application being executed and acquired as an image by the information recording application. The window of the application is displayed on a monitor in the entire desktop image. The screen information representing the screen displayed by the application can be acquired by another application (e.g., the information recording application) as an image file or a moving image file formed of a plurality of consecutive images via an API of the OS or an API of the application that displays the screen. Further, the screen information representing the desktop screen is information formed from an image of the desktop screen generated by the OS. In substantially the same manner as the screen information representing the screen displayed by the application, the screen information representing the desktop screen can be acquired as an image file or a moving image file via the API of the OS. The format of these image files is, for example, bitmap, Portable Network Graphics (PNG), or any other format. The format of the moving image file is, for example, MP4 or any other format.

The audio acquisition unit 15 acquires audio data received by the terminal apparatus from the teleconference application 42 in a teleconference. Note that the audio data acquired by the audio acquisition unit 15 does not include audio data acquired by the terminal apparatus 10, but includes only the audio data received in the teleconference through the teleconference application 42. This is because the meeting device 60 separately receives audio.

The device communication unit 16 communicates with the meeting device 60 using a USB cable or the like. Alternatively, the device communication unit 16 may use a wireless local area network (LAN) or BLUETOOTH to communicate with the meeting device 60. The device communication unit 16 receives the panoramic image and the talker image from the meeting device 60, and transmits the audio data acquired by the audio acquisition unit 15 to the meeting device 60. The device communication unit 16 receives audio data synthesized by the meeting device 60.

The recording control unit 17 combines the panoramic image and the talker image received by the device communication unit 16 and an application screen acquired by the application screen acquisition unit 14 to generate a combined image. In addition, the recording control unit 17 connects, in time series, combined images that are repeatedly generated by the recording control unit 17 to generate a composite moving image, and further combines the synthesized audio data and the composite moving image to generate a composite moving image with audio. Alternatively, the panoramic image and the talker image may be combined by the meeting device 60 instead of the recording control unit 17. Further, each of moving images respectively formed of panoramic images, talker images, application screens, and images formed of panoramic images and talker images may be separately stored in the storage service system 70 as an individual moving image file. In this case, for example, a moving image formed of panoramic images, a moving image formed of talker images, a moving image formed of application screens, and a moving image that is formed of images formed of a panoramic image and a talker image are read out at the time of viewing to be displayed on a single display screen all together.

The audio data processing unit 18 requests the information processing system 50 to convert the audio data extracted by the recording control unit 17 from the composite moving image with audio or the synthesized audio data received from the meeting device 60 into text data.

The video replay unit 19 reproduces the composite moving image. The composite moving image is stored in the terminal apparatus 10 during recording, and then uploaded to the information processing system 50.

When the teleconference ends, the upload unit 20 transmits the composite moving image to the information processing system 50.

The edit processing unit 21 performs editing (e.g., deleting a part, connecting parts) of the composite moving image according to a user operation.

The code analysis unit 22 detects and analyzes a two-dimensional code or a bar code included in the panoramic image to acquire conference participation information. The conference participation information includes, for example, information indicating that the device is usable for the conference, a device identifier of the electronic whiteboard 2 stored in a device information storage unit 3001, a conference identification (ID) (selected by the user), and an IP address of the electronic whiteboard 2. The device identifier is, for example, either a serial number or a universally unique identifier of the electronic whiteboard 2. Alternatively, the device identifier may be set by the user. The conference ID is assigned at the time of registering the schedule of the conference or at the time of starting recording. The conference ID may be associated with a teleconference ID assigned by the teleconference service system 90.

In a case where the meeting device 60 acquires the conference participation information, the mute request unit 23 requests the electronic whiteboard 2 to be muted.

The audio data analysis unit 24 performs spectrum analysis (Fourier transform) on audio data output from the electronic whiteboard 2 to detect a frequency included in the audio data, and converts a specific frequency into bit data to decode the conference participation information included in an audio signal of the audio data. Alternatively, the audio data analysis unit 24 may acquire the conference participation information using speech recognition.

The beacon data analysis unit 25 acquires the conference participation information included in beacon data transmitted from the meeting device 60.

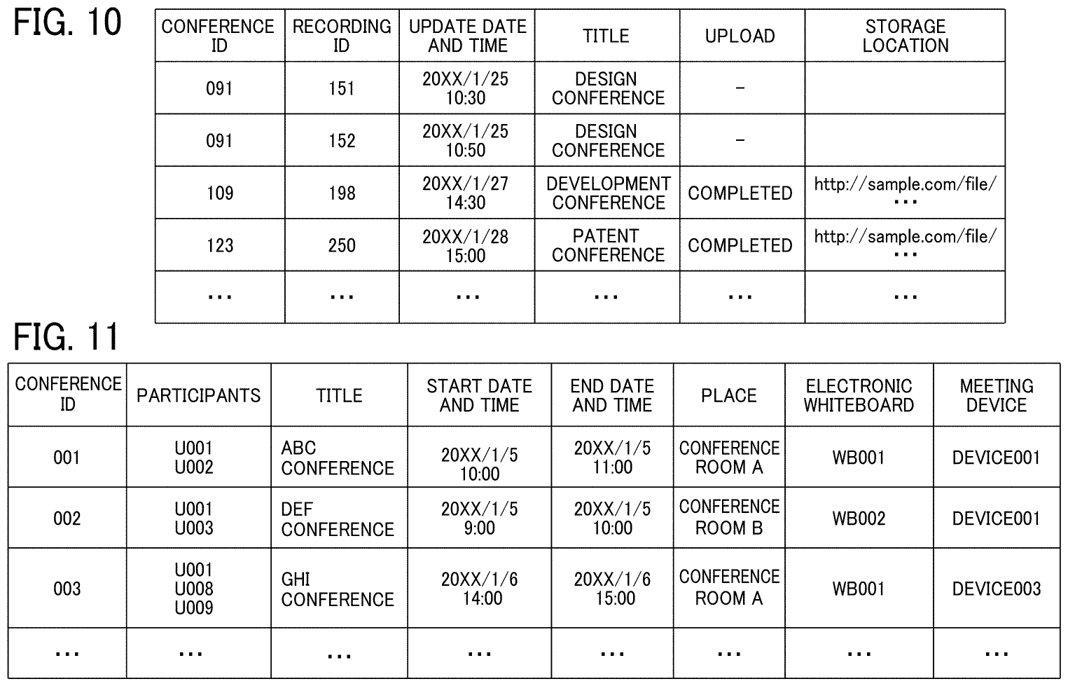

FIG. 10 is a table illustrating an example of a record of moving image stored in the information storage unit 1001 according to the present embodiment. The record of moving image includes, as data items, “conference ID,” “recording ID,” “update date and time.” “title,” “upload,” and “storage location.” When the user logs in to the information processing system 50, the information recording application 41 downloads conference information from a conference information storage unit 5001 included in the information processing system 50. The conference ID included in the conference information is reflected in the record of moving image. The record of moving image illustrated in FIG. 10 is a table held by the terminal apparatus 10 operated by a certain user.

The item “conference ID” represents an identifier used for identifying a teleconference that has been held. The conference ID is assigned when a schedule of the teleconference is registered in a conference management system 9, or is assigned by the information processing system 50 in response to a request from the information recording application 41. The conference management system 9 is a system in which a schedule of a conference or a teleconference, a uniform resource locator (URL) such as a link to a teleconference for starting the teleconference, and reservation information of devices to be used in the conference or the teleconference are registered. In other words, the conference management system 9 is, for example, a scheduler to which the terminal apparatus 10 connects via a network. In addition, the conference management system 9 can transmit the registered schedule and the like to the information processing system 50.

The item “recording ID” represents an identifier used for identifying a composite moving image recorded in the teleconference. The recording ID is assigned by the meeting device 60. Alternatively, the recording ID may be assigned by the information recording application 41 or the information processing system 50. Different recording IDs are assigned to a same conference ID in a case where the recording is suspended in the middle of the teleconference but is started again for some reason.

The item “update date and time” represents a date and time when a composite moving image is updated (or recording is ended). In a case where the composite moving image is edited, the update date and time is a date and time when the editing is performed.

The item “title” represents a name of a conference (or a teleconference). The title may be set when the schedule of the conference is registered in the conference management system 9, or may be freely set by the user.

The item “upload” indicates whether a composite moving image has been uploaded to the information processing system 50.

The item “storage location” indicates a location (a URL or a file path) where a composite moving image and text data are stored in the storage service system 70. Thus, the user can view the composite moving image uploaded to the information processing system 50 as desired. The composite moving image and the text data are stored with different file names starting with the same URL, for example.

Meeting Device

Returning to FIG. 9, the description continues. The meeting device 60 includes a terminal communication unit 61, a panoramic image generation unit 62, a talker image generation unit 63, an audio collection unit 64, an audio synthesis unit 65, and a short-range wireless communication unit 66. These units of functions included in the meeting device 60 are implemented by or caused to function by one or more of the hardware components illustrated in FIG. 5 operating in accordance with instructions from the CPU 611 according to the control program loaded from the ROM 612 to the DRAM 614. The terminal communication unit 61 communicates with the terminal apparatus 10 using a USB cable or the like. The terminal communication unit 61 is not only connected with the terminal apparatus 10 by a wired cable, but also is communicable with the terminal apparatus 10 by a wireless LAN, BLUETOOTH, or the like.

The panoramic image generation unit 62 generates a panoramic image. The talker image generation unit 63 generates a talker image. The methods of generating the panoramic image and the talker image are already described with reference to FIGS. 6 and 7. Note that the panoramic image generation unit 62 also serves as an acquisition unit that acquires a two-dimensional code in which conference participation information is included.

The audio collection unit 64 converts audio received by a microphone of the meeting device 60 into audio data (digital data). Accordingly, the contents spoken by the user and the participants at the site where the terminal apparatus 10 is located are collected. Note that the audio collection unit 64 also serves as an acquisition unit that acquires an audio signal in which conference participation information is included.

The audio synthesis unit 65 synthesizes the audio transmitted from the terminal apparatus 10 and the audio collected by the audio collection unit 64. Accordingly, the audio spoken at the other site 101 and the contents spoken at the own site 102 are synthesized.

The short-range wireless communication unit 66 (an example of a first short-range wireless communication unit) receives a radio wave (beacon) such as BLUETOOTH or Wi-Fi, and demodulates the radio wave to extract data. Note that the short-range wireless communication unit 66 also serves as an acquisition unit that acquires beacon data in which conference participation information is included.

Information Processing System

The information processing system 50 includes a communication unit 51, an authentication unit 52, a screen generation unit 53, a communication management unit 54, a device management unit 55, and a text conversion unit 56. These units of functions included in the information processing system 50 are implemented by or caused to function by one or more of the hardware components illustrated in FIG. 4 operating in accordance with instructions from the CPU 501 according to the control program loaded from the HD 504 to the RAM 503. The information processing system 50 also includes a storage unit 5000 implemented by the HD 504 illustrated in FIG. 4. The storage unit 5000 includes the conference information storage unit 5001, a record storage unit 5002, and an association information storage unit 5003 each of which is implemented by a database.

The communication unit 51 transmits and receives various types of information to and from the terminal apparatus 10 via a communication network. The communication unit 51, for example, transmits a list of teleconferences to the terminal apparatus 10 and receives a request for performing speech recognition from the terminal apparatus 10.

The authentication unit 52 authenticates a user who operates the terminal apparatus 10. The authentication unit 52 authenticates the user by, for example, determining whether authentication information (a user ID and a password) included in a request for authentication received by the communication unit 51 matches authentication information stored in advance. Alternatively, a card number of an integrated circuit (IC) card, biometric authentication information such as a face or a fingerprint, or the like may be used as the authentication information. Further, the authentication unit 52 may authenticate the user by using an external authentication system or an authentication method such as an open authentication standard (OAuth).

The screen generation unit 53 generates screen information representing a screen to be displayed by the terminal apparatus 10. In a case where the terminal apparatus 10 executes a native application, the screen information is held by the terminal apparatus 10, and the screen information representing the screen to be displayed is transmitted in a format of Extensible Markup Language (XML) or the like. In a case where the terminal apparatus 10 executes a web application, the screen information is generated in a format of hypertext markup language (HTML), XML, cascading style sheets (CSS), JAVASCRIPT, or the like.

The communication management unit 54 acquires information relating to a teleconference from the conference management system 9 using an account of each user or a system account assigned by the information processing system 50. The communication management unit 54 stores conference information of a scheduled teleconference and the conference ID in the conference information storage unit 5001 in association with each other. In addition, the communication management unit 54 acquires conference information for which a user belonging to a tenant has a viewing authority. Since the conference ID is set for the teleconference, the teleconference and the record of conference are associated with each other by the conference ID.

In response to receiving device identifiers of the electronic whiteboard 2 and the meeting device 60, the device management unit 55 stores the device identifiers of the electronic whiteboard 2 and the meeting device 60 to be used in the teleconference in the association information storage unit 5003 in association with the teleconference. Accordingly, the conference ID, the device identifier of the electronic whiteboard 2, and the device identifier of the meeting device 60 are associated with each other. Since a composite moving image is also associated with the conference ID, object data and the composite moving image are also associated with each other by the conference ID. When recording ends (when the teleconference ends), the device management unit 55 deletes the association from the association information storage unit 5003.

The text conversion unit 56 converts audio data requested to be converted into text data by the terminal apparatus 10 into text data using an external service system such as the speech recognition service system 80. Alternatively, the text conversion unit 56 may perform the conversion without using the external service system such as the speech recognition service system 80.

FIG. 11 is a table illustrating an example of conference information stored in the conference information storage unit 5001 and managed by the communication management unit 54 according to the present embodiment. The communication management unit 54 acquires a list of teleconferences for which a user belonging to a tenant has a viewing authority by using the above-described account. In the present embodiment, teleconferences are used as examples. However, the list of teleconferences also includes conferences held in a single conference room. The viewing authority may be given directly from the information recording application 41 operating on the terminal apparatus 10 to conference information managed by the communication management unit 54. The list of teleconferences for which the user belonging to the tenant has the viewing authority includes conferences set by the user and conferences for which other users give the viewing authority to the user.

The conference information includes, as data items, “conference ID,” “participant,” “title (a name of a conference),” “start data and time,” “end date and time,” “place,” “electronic whiteboard,” and “meeting device.” The conference information is managed with the conference ID, which is associated with the item “participant,” the item “title.” the item “start date and time.” the item “end date and time,” the item “place,” and the like. These are examples of items included in the conference information, and the conference information may include other items.

The item “participant” represents a participant of the conference.

The item “title” represents a content of the conference such as a name of the conference or an agenda of the conference.

The item “start date and time” represents the date and time when the conference is scheduled to be started.

The item “end date and time” represents the date and time when the conference is scheduled to be ended.

The item “place” represents a place where the conference is held such as a name of a conference room, a name of a branch office, or a name of a building.

The item “electronic whiteboard” represents a device identifier of the electronic whiteboard 2 used in the conference.

The item “meeting device” represents a device identifier of the meeting device 60 used in the conference.

As illustrated in FIGS. 10 and 11, the composite moving image recorded in a conference is identified with the conference ID.

The record stored in the record storage unit 5002 may be the same as the record of moving image illustrated in FIG. 10. However, the information processing system 50 has a list of composite moving images recorded by all users belonging to the tenant. The user may input desired storage location information on a user setting screen of the information recording application 41 operating on the terminal apparatus 10, so that the storage location (path information such as a URL of a cloud storage system) is stored in the record storage unit 5002.

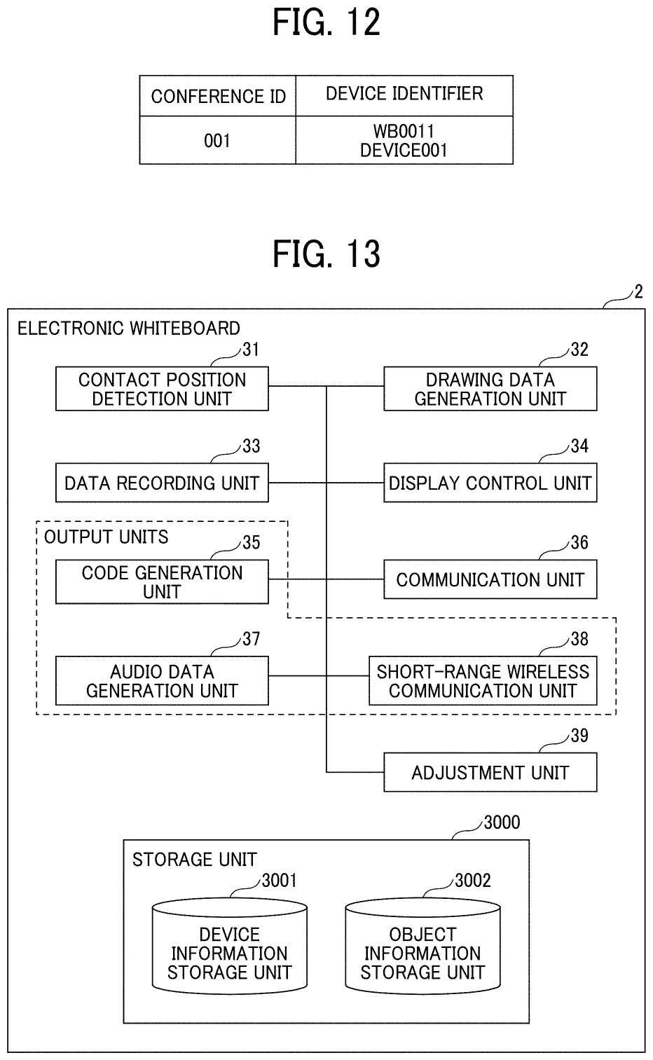

FIG. 12 is a table illustrating an example of association information associating a conference ID with device identifiers of the electronic whiteboard 2 and the meeting device 60 according to the present embodiment. The association information is stored in the association information storage unit 5003. The association information is retained from the time of participation in the conference until the end of the conference (exit from the conference).

Electronic Whiteboard

FIG. 13 is a block diagram illustrating functional configurations of the electronic whiteboard 2 according to the present embodiment. The electronic whiteboard 2 includes a contact position detection unit 31, a drawing data generation unit 32, a data recording unit 33, a display control unit 34, a code generation unit 35, a communication unit 36, an audio data generation unit 37, a short-range wireless communication unit 38, and an adjustment unit 39. These units of functions included in the electronic whiteboard 2 are implemented by or caused to function by one or more of the hardware components illustrated in FIG. 8 operating in accordance with instructions from the CPU 401 according to the control program loaded from the SSD 404 to the RAM 403.

The contact position detection unit 31 detects coordinates of a position contacted by the electronic pen 490 on the contact sensor 414. The drawing data generation unit 32 acquires the coordinates of the position contacted by the tip of the electronic pen 490 from the contact position detection unit 31. The drawing data generation unit 32 interpolates and connects the contact coordinates into a coordinate point sequence, to generate stroke data.

The display control unit 34 displays, on a display, for example, handwritten data, a character string converted from the handwritten data, and an operation menu to be operated by the user.

The data recording unit 33 stores, in an object information storage unit 3002, for example, handwritten data handwritten on the electronic whiteboard 2, a graphic such as a circle or triangle into which the handwritten data is converted, a stamp representing completion or the like, a screen of a PC, and a file. Each of the handwritten data, the character string (including a graphic), an image such as the screen of the PC, the file is treated as an object. Regarding the handwritten data, a set of stroke data is treated as one object in accordance with separation by time due to interruption of input of handwriting or by distance between positions where handwritings are input.

The communication unit 36 is connected to a Wi-Fi or a LAN, and communicates with the information processing system 50. The communication unit 36 transmits object information to the information processing system 50, receives object information stored in the information processing system 50 from the information processing system 50, and causes the display 480 to display an object represented by the object information received from the information processing system 50.

The code generation unit 35 generates a two-dimensional code by encoding conference participation information into a two-dimensional pattern. Alternatively, the code generation unit 35 may encode the conference participation information into a bar code. Note that the code generation unit 35 also serves as an output unit that outputs a two-dimensional code or a bar code in which conference participation information is included.

The audio data generation unit 37 converts each of an alphabet and a number into a frequency that continues for a certain time, and generates an audio signal by a method similar to pulse code modulation (PCM) conversion that samples the frequency at a certain interval. For example, the audio data generation unit 37 expresses each of the alphabet and the number in an American Standard Code for Information Interchange (ASCII) code, and makes 19 kHz and 20 kHz correspond to 0 and 1 in the binary numeral system respectively. The audio signal is converted into an analog signal by an analog-to-digital (A/D) converter included in the speaker 450 and output from the speaker 450. Note that the audio data generation unit 37 also serves as an output unit that outputs an audio signal in which conference participation information is included.

The short-range wireless communication unit 38 (an example of a second short-range wireless communication unit) modulates data, combines the modulated data with a carrier wave, and transmits the resultant as a beacon from an antenna. The short-range wireless communication unit 38 also serves as an output unit that transmits a beacon in which conference participation information is included.

The adjustment unit 39 adjusts audio volume of at least one of the microphone 440 and the speaker 450 included in the electronic whiteboard 2 in response to a request from the terminal apparatus 10. The adjustment unit 39 mutes either the microphone 440 or the speaker 450, for example.

The electronic whiteboard 2 also includes a storage unit 3000 implemented by the SSD 404 illustrated in FIG. 8. The storage unit 3000 includes the device information storage unit 3001 and the object information storage unit 3002 each of which is implemented by a database.

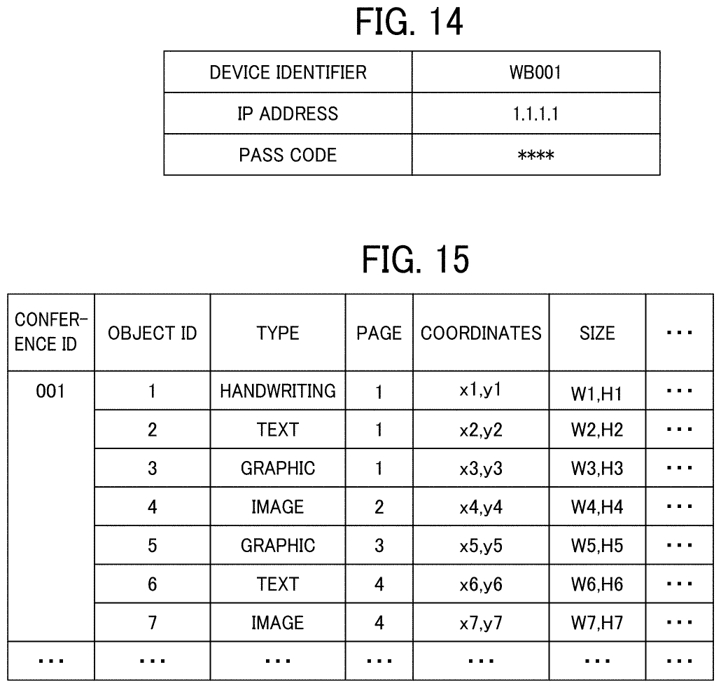

FIG. 14 is a table illustrating an example of device identification information stored in the device information storage unit 3001 according to the present embodiment. The device identification information includes, as data items, “device identifier,” “IP address,” and “passcode.” The item “device identifier” represents a device identifier of the electronic whiteboard 2. The item “IP address” represents an IP address used for another device to connect to the electronic whiteboard 2 via a network. The item “passcode” is used for authentication when another device connects to the electronic whiteboard 2.

FIG. 15 is a table illustrating an example of object information stored in the object information storage unit 3002 according to the present embodiment. The object information is information used for managing an object displayed by the electronic whiteboard 2. The object information is transmitted to the information processing system 50 and used in minutes. In a case where the electronic whiteboard 2 is located at another site when the teleconference is held, the object information is shared with the own site.

The conference information includes, as data items, “conference ID,” “object ID,” “type.” “coordinates,” “size,” and the like. The item “conference ID” represents an identifier of a conference notified from the information processing system 50.

The item “object ID” represents an identifier used for identifying an object.

The item “type” represents a type of object. Examples of the type of object are “handwriting,” “text,” “graphic,” and “image.” The type “handwriting” represents stroke data (coordinate point sequence). The type “text” represents a character string (character code) converted from handwritten data. In some cases, the character string may be referred to as text data. The type “graphic” represents a geometric shape converted from handwritten data, such as a triangle or a tetragon. The type “image” represents image data in a format such as Joint Photographic Experts Group (JPEG), PNG, or Tagged Image File Format (TIFF) acquired from, for example, a PC or the Internet.

A single screen of the electronic whiteboard 2 is referred to as a page. The item “page” represents the number of the page.

The item “coordinates” represents a position of an object with reference to a predetermined origin on the screen of the electronic whiteboard 2. The position of the object is, for example, the upper left apex of a circumscribed rectangle of the object. The coordinates are expressed, for example, in units of pixels of a display.

The item “size” represents a width and a height of the circumscribed rectangle of the object.

Muting Procedure

Descriptions are given below of several muting procedures. It is assumed that both the meeting device 60 and the electronic whiteboard 2 are powered on and connected to the network.

Muting Procedure 1

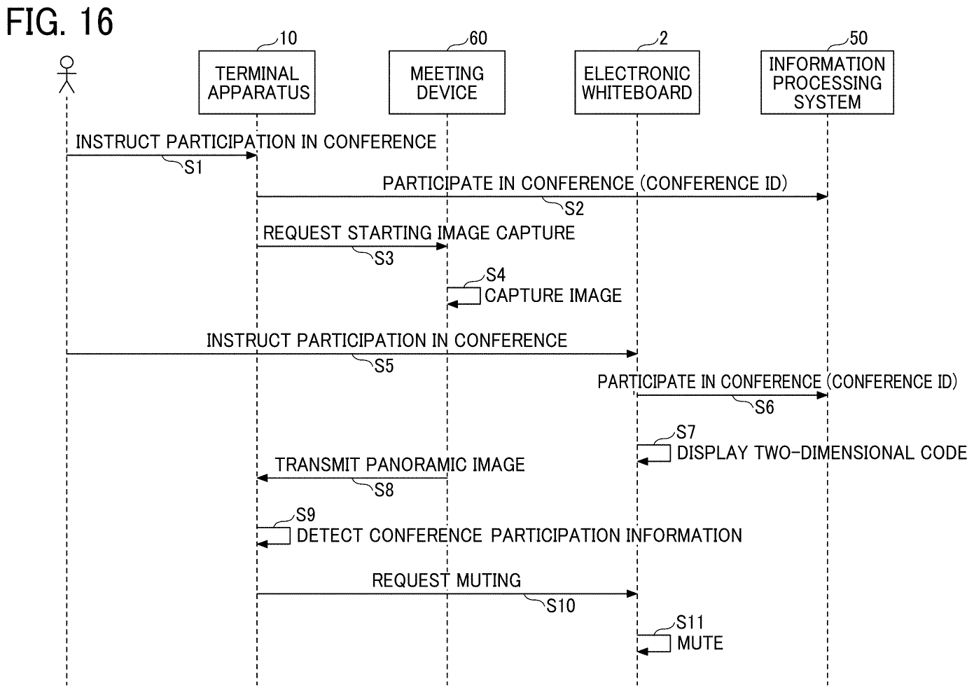

FIG. 16 is a sequence chart illustrating an example of processing executed by the electronic whiteboard 2 to mute audio input and output in response to participation in a conference according to the present embodiment.

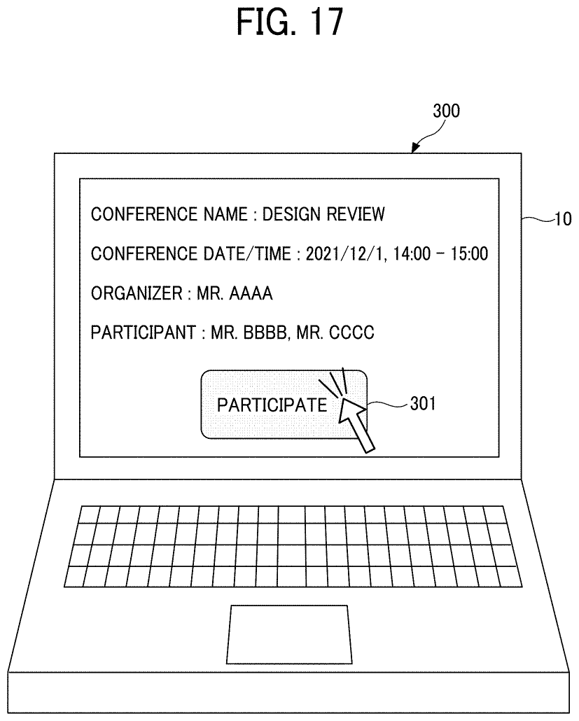

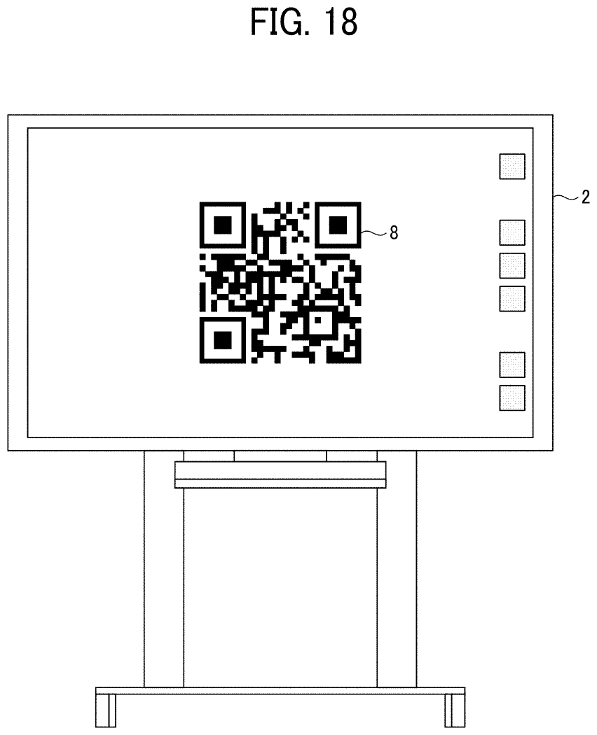

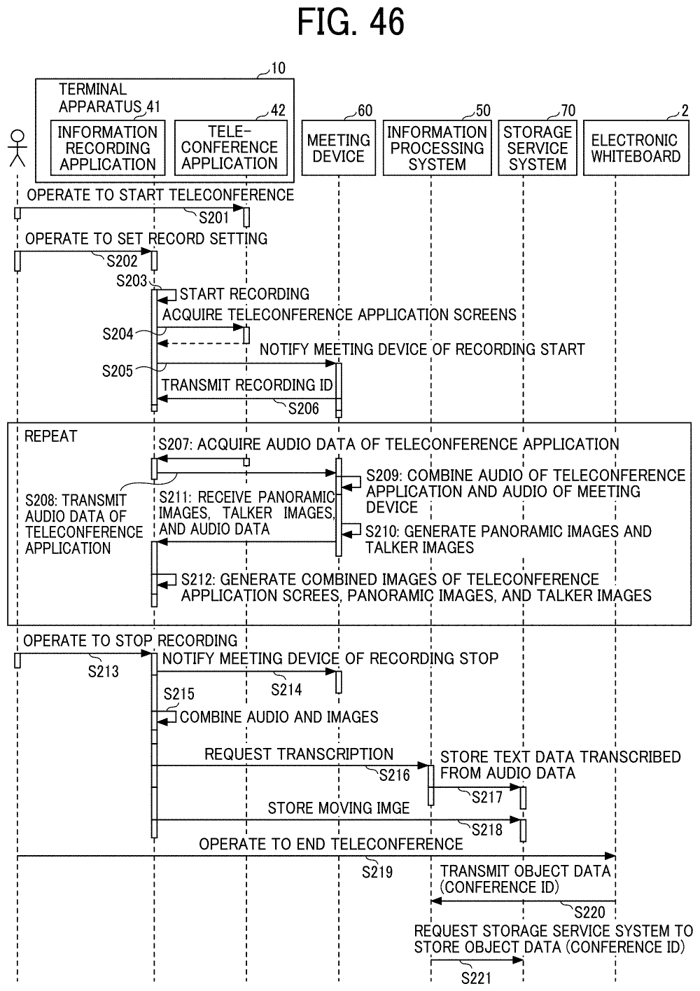

S1: First, the user instructs the information recording application 41 operating on the terminal apparatus 10 to participate in a conference. The operation reception unit 12 implemented by the information recording application 41 receives the instruction to participate in the conference. The term “to participate in a conference” refers to transmitting a request for participation in a conference to the information processing system 50 with designation of the conference. When the terminal apparatus 10 participates in the conference, the device identifier of the meeting device 60 is associated with the conference ID in the association information. Alternatively, an operation to start recording, which will be described later in FIG. 46, may serve as participation in the conference. The request for participation in the conference may start muting control (detection of a two-dimensional code) in some cases. The participation in the conference of the teleconference service system is performed separately from the participation in the conference that starts the muting control. An example of a screen for participating in a conference is illustrated in FIG. 17.

S2: The communication unit 11 implemented by the information recording application 41 transmits the request for participation in the conference (a notification of participation) to the information processing system 50 with designation of the conference ID selected by the user. The communication unit 11 also transmits the device identifier of the meeting device 60 to the information processing system 50. The communication unit 51 of the information processing system 50 receives the request for participation (the conference ID, the device identifier of the meeting device 60) from the terminal apparatus 10. The device management unit 55 of the information processing system 50 stores the device identifier of the meeting device 60 and the conference ID in association with each other. At this time, an IP address of the terminal apparatus 10 is also grasped.

The conference ID referred in this case is a conference ID managed by the conference management system 9. Alternatively, a teleconference ID assigned by the teleconference service system 90 for management may be used as the conference ID. Accordingly, the conference registered in the teleconference service system 90 and the devices used in the conference are associated with each other.

Note that the teleconference application 42 separately starts transmission and reception of images and audio to and from the teleconference service system 90 by communicating with the teleconference service system 90 in response to a user operation.

S3: When the terminal apparatus 10 participates in the conference, the terminal apparatus 10 starts processing (device detection processing) for detecting whether there is a device participating in the same conference in which the terminal apparatus 10 participate in the same conference room where the terminal apparatus 10 is located. In this example, the device detection processing is performed with an image captured by a camera. The device communication unit 16 implemented by the information recording application 41 requests the meeting device 60 to start capturing an image.

S4: When the terminal communication unit 61 of the meeting device 60 receives the request for starting to capture an image, the panoramic image generation unit 62 of the meeting device 60 repeatedly generates a panoramic image.

S5: Next, the user activates a meeting application on the electronic whiteboard 2 and instructs the electronic whiteboard 2 to participate in the conference. The contact position detection unit 31 of the electronic whiteboard 2 receives the request for participation in the conference. The request for participation in the conference may start muting control (display of a two-dimensional code) in some cases. A method of instructing the electronic whiteboard 2 to participate in the conference may be the same as the method of instructing the terminal apparatus 10 to participate in the conference.

S6: The communication unit 36 of the electronic whiteboard 2 transmits the request for participation in the conference (a notification of participation) to the information processing system 50 with designation of the conference ID selected by the user. The communication unit 36 transmits the device identifier of the electronic whiteboard 2 to the information processing system 50. The communication unit 51 of the information processing system 50 receives the request for participation (the conference ID, the device identifier of the electronic whiteboard 2) from the electronic whiteboard 2. The device management unit 55 of the information processing system 50 stores the device identifier of the electronic whiteboard 2 and the conference ID in association with each other as association information. At this time, the IP address of the electronic whiteboard 2 is also grasped. Accordingly, the electronic whiteboard 2 and the meeting device 60 are associated with each other with the conference ID. In a case where the electronic whiteboard 2 transmits object data together with the conference ID to the information processing system 50, the object data and a composite moving image can be stored in association with each other in minutes of the same conference.

S7: When the electronic whiteboard 2 participates in the conference, the code generation unit 35 of the electronic whiteboard 2 generates a two-dimensional code in which conference participation information is included. The conference participation information includes, for example, information indicating that the device is usable for the conference, the device identifier of the electronic whiteboard 2, the conference ID, and the IP address of the electronic whiteboard 2. The display control unit 34 of the electronic whiteboard 2 displays the two-dimensional code for a certain time. An example of the display of the two-dimensional code is illustrated in FIG. 18. The certain time (for example, from several seconds to several minutes) is set so that the two-dimensional code does not disturb the conference. Note that the conference participation information includes either the device identifier or the IP address of the electronic whiteboard 2, depending on a path through which the terminal apparatus 10 communicates with the electronic whiteboard 2.

S8: The panoramic image generation unit 62 of the meeting device 60 generates a panoramic image in which the two-dimensional code is included. The terminal communication unit 61 transmits the panoramic image to the terminal apparatus 10.

In a case where the two-dimensional code includes information indicating whether the electronic whiteboard 2 is currently in a mute state, the meeting device 60 may mute the microphone or the speaker of the meeting device 60. Howling can be prevented by muting audio input or output of the meeting device 60, or audio input or output of the electronic whiteboard 2. In a case where the meeting device 60 determines that the electronic whiteboard 2 is not in the mute state (the audio volume is greater than zero) with the two-dimensional code, the meeting device 60 mutes the microphone or the speaker of the meeting device 60.

S9: When the device communication unit 16 implemented by the information recording application 41 operating on the terminal apparatus 10 receives the panoramic image, the code analysis unit 22 implemented by the information recording application 41 monitors the panoramic image and continuously determines whether the panoramic image includes a two-dimensional code including information indicating a device to be used in a conference (whether conference participation information is included). In a case where the panoramic image does not include the two-dimensional code, the code analysis unit 22 does nothing and continues to monitor the panoramic image until the code analysis unit 22 determines that the two-dimensional code is included in the panoramic image.

In a case where the panoramic image includes the two-dimensional code including the information indicating a device to be used in a conference, the information recording application 41 detects presence of the electronic whiteboard 2. The mute request unit 23 implemented by the information recording application 41 compares the conference ID included in the two-dimensional code with the conference ID selected in step S2 to determine whether the electronic whiteboard 2 is participating in the same conference in which the meeting device 60 is participating. In this way, a plurality of devices in the same conference room is prevented from being associated with different conferences. Alternatively, the determination in step S9 can also be performed by the meeting device 60 instead of the code analysis unit 22.

S10: In a case where the meeting device 60 is participating in the same conference in which the electronic whiteboard 2 is participating, the mute request unit 23 requests the electronic whiteboard 2 to mute at least one of the microphone 440 and the speaker 450 (an example of an adjustment request) with the IP address of the electronic whiteboard 2 as a destination via the communication unit 11. In a case where the terminal apparatus 10 and the electronic whiteboard 2 are connected to the same LAN (same network address or connected to the same service set identifier (SSID)), the terminal apparatus 10 can communicate with the electronic whiteboard 2 with the IP address of the electronic whiteboard 2. Note that the conference participation information may include a passcode for authentication. In this case, the mute request unit 23 preferably also transmits the passcode to the electronic whiteboard 2. Use of a Web Application Programming Interface (Web API) published by the electronic whiteboard 2 is a preferable example of a method of instructing muting, but the method is not limited thereto.

The electronic whiteboard 2 receives the mute request from the terminal apparatus 10 in step S10. Alternatively, the electronic whiteboard 2 may receive the mute request directly from the meeting device 60.

S11: The communication unit 36 of the electronic whiteboard 2 receives the mute request. Then, the adjustment unit 39 of the electronic whiteboard 2 mutes at least one of the microphone 440 and the speaker 450. In addition, when at least one of the microphone 440 and the speaker 450 is muted, the display control unit 34 stops displaying the two-dimensional code. An example of a screen displayed by the electronic whiteboard 2 in the mute state is illustrated in FIG. 27.

In a case where the electronic whiteboard 2 does not receive a mute request, for example, when the meeting device 60 and the electronic whiteboard 2 are located in different conference rooms or participate in different conferences, the electronic whiteboard 2 stops displaying the two-dimensional code after a certain period of time (e.g., one minute) elapses from the start of displaying the two-dimensional code. In this case, muting is not performed. Accordingly, a state in which the two-dimensional code is left being displayed can be prevented. The period of time for displaying the two-dimensional code may be set by the user.

Further, the monitoring the two-dimensional code performed by the terminal apparatus 10 may be terminated after a certain period of time (e.g., 10 minutes) elapses, for example. However, a device that participates in the conference after the monitoring is terminated cannot be detected in this case. For this reason, the monitoring is continued in the present embodiment.

Although the user instructs the terminal apparatus 10 to participate in the conference first in FIG. 16, the user may instruct the electronic whiteboard 2 to participate in the conference first or may instruct the terminal apparatus 10 and the electronic whiteboard 2 to participate in the conference simultaneously.

FIG. 17 is a diagram illustrating an example of a screen 300 for participating in a conference displayed by the terminal apparatus 10 according to the present embodiment. The screen 300 for participating in a conference is a screen for displaying conference information and includes a participate button 301. When the user presses the participate button 301, a notification of participation in a conference designated with a conference ID is transmitted to the information processing system 50.

FIG. 18 is a diagram illustrating an example of the two-dimensional code 8 displayed by the electronic whiteboard 2 according to the present embodiment. As the two-dimensional code 8, a single large two dimensional code is displayed in FIG. 18. The meeting device 60 easily detects the two-dimensional code 8 of the large size. A description is given below of a method of displaying the two-dimensional code 8.

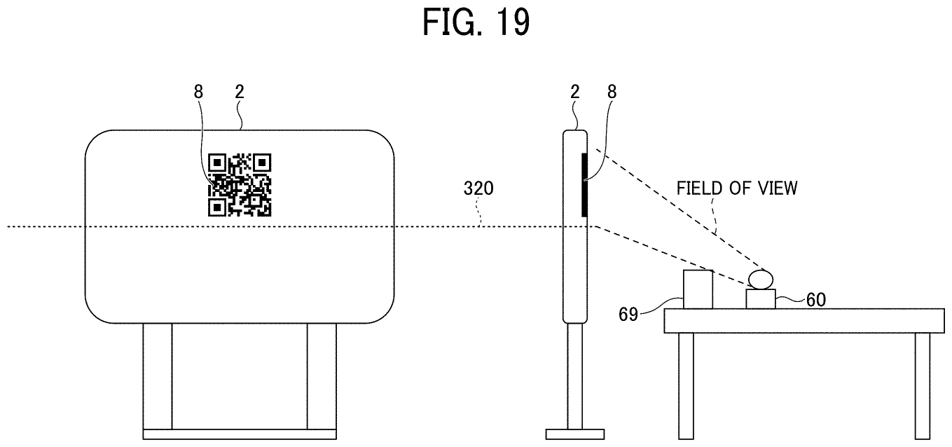

FIG. 19 is a schematic diagram illustrating an example of a position of the two-dimensional code 8 displayed by the electronic whiteboard 2 according to the present embodiment. As described above, the two-dimensional code 8 includes the device identifier and the information indicating a device to be used in a conference. On the desk where the meeting device 60 is placed, there is an obstacle 69 between the meeting device 60 and the electronic whiteboard 2. Note that the camera included in the meeting device 60 is not necessarily a spherical camera for detecting the two-dimensional code 8. The electronic whiteboard 2 displays the two-dimensional code 8 above a center line 320 of the display screen of the electronic whiteboard 2 in the vertical direction. Thus, even if the obstacle 69 exists between the meeting device 60 and the electronic whiteboard 2, the meeting device 60 can easily capture an image of the two-dimensional code 8.

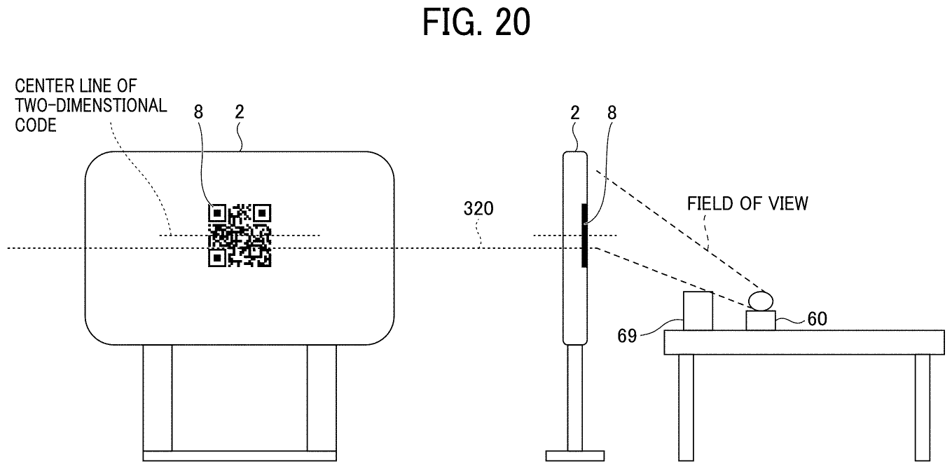

As illustrated in FIG. 20, the electronic whiteboard 2 may display the center of the two-dimensional code 8 above the center line 320 of the display screen of the electronic whiteboard 2 in the vertical direction.

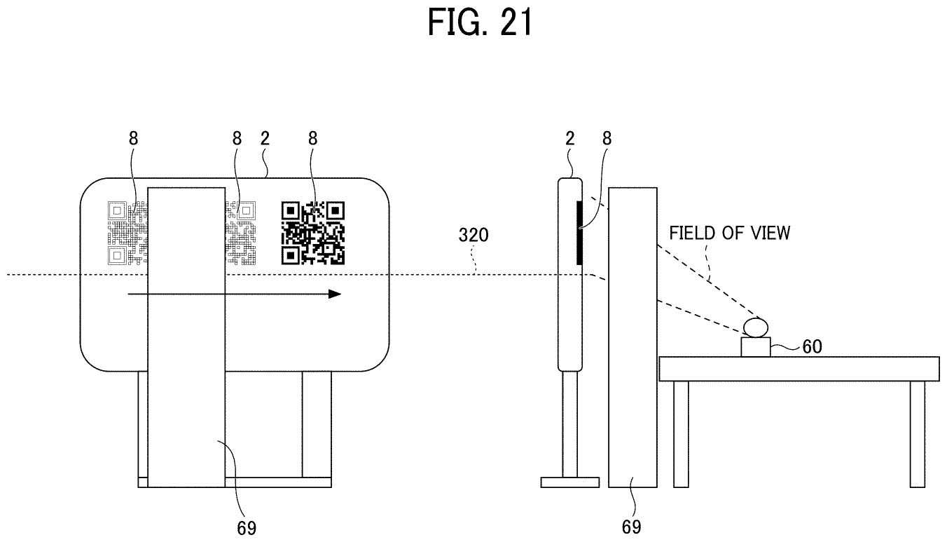

Alternatively, as illustrated in FIG. 21, the electronic whiteboard 2 may move the two-dimensional code 8 according to an elapsed time. In FIG. 21, the two-dimensional code 8 moves from left to right. The electronic whiteboard 2 may move the two-dimensional code 8 being displayed. Alternatively, the electronic whiteboard 2 may display the two-dimensional code 8, stop displaying the two-dimensional code 8, and again display the two-dimensional code 8 at a different position. Thus, even if a position of the obstacle 69 is uncertain, the meeting device 60 can easily capture an image of the two-dimensional code 8. Further, even when the electronic whiteboard 2 displays the two-dimensional code 8 in a small size in order to reduce the feeling of pressure on the user, the meeting device 60 can easily capture the image of the two-dimensional code 8.

Furthermore, the electronic whiteboard 2 may change the size of the two-dimensional code 8 while moving the two-dimensional code 8.

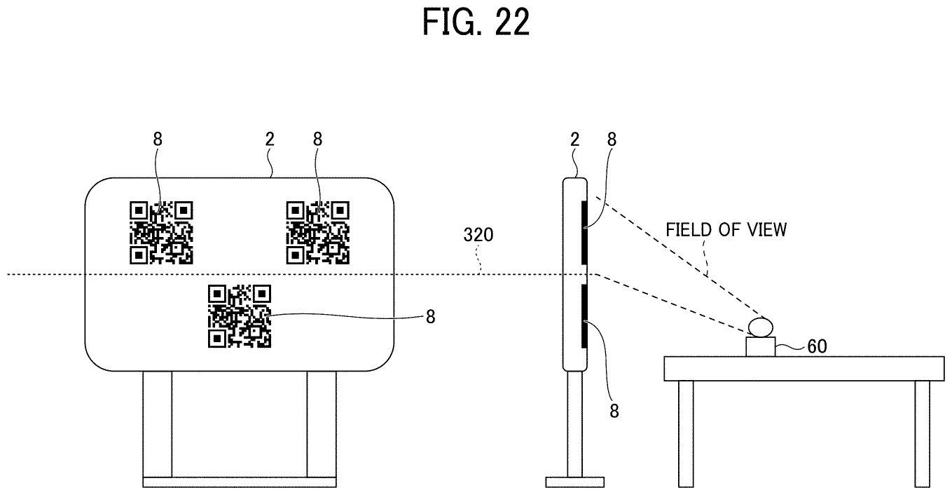

Alternatively, as illustrated in FIG. 22, the electronic whiteboard 2 may simultaneously display a plurality of two-dimensional codes 8. Thus, even if some of the plurality of two-dimensional codes 8 are hidden by the obstacle 69, the meeting device 60 can easily capture images of the others of the plurality of two-dimensional codes 8. All of the plurality of two-dimensional codes 8 may include the same information, or each of the plurality of two-dimensional codes 8 may include different information.

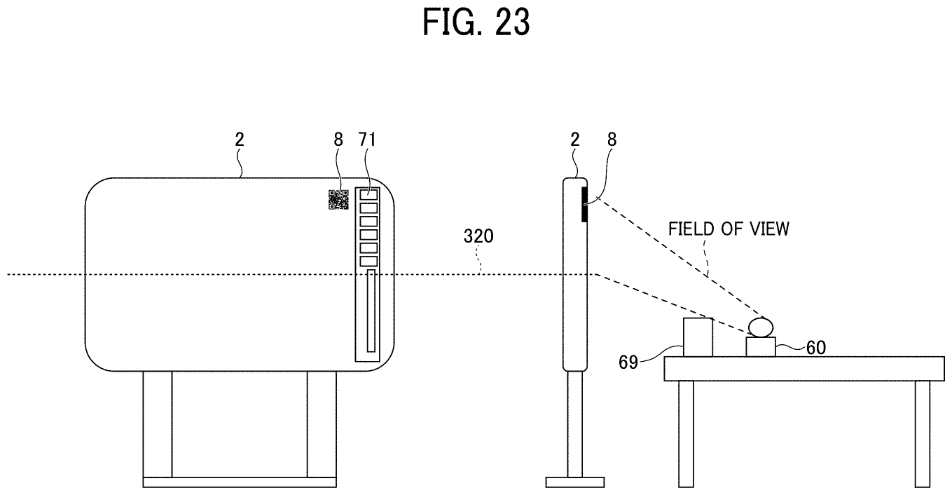

Alternatively, as illustrated in FIG. 23, the electronic whiteboard 2 may display the two-dimensional code 8 at a position adjacent to (close to) a menu 71. The menu 71 is arranged over the right end in the vertical direction. Similar to FIG. 19, the two-dimensional code 8 is displayed above the center line 320 of the display screen of the electronic whiteboard 2 in the vertical direction.

Since the two-dimensional code 8 is displayed close to the menu 71, the user is less likely to feel discomfort. In addition, the user can use the screen widely.

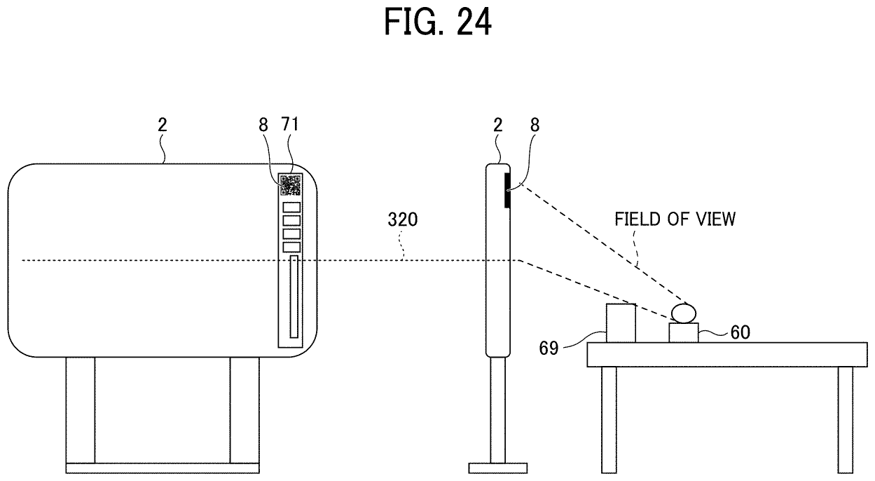

Alternatively, as illustrated in FIG. 24, the electronic whiteboard 2 may display the two-dimensional code 8 in the menu 71. Compared with the example of FIG. 23, the user is much less likely to feel discomfort and can use the screen more widely.

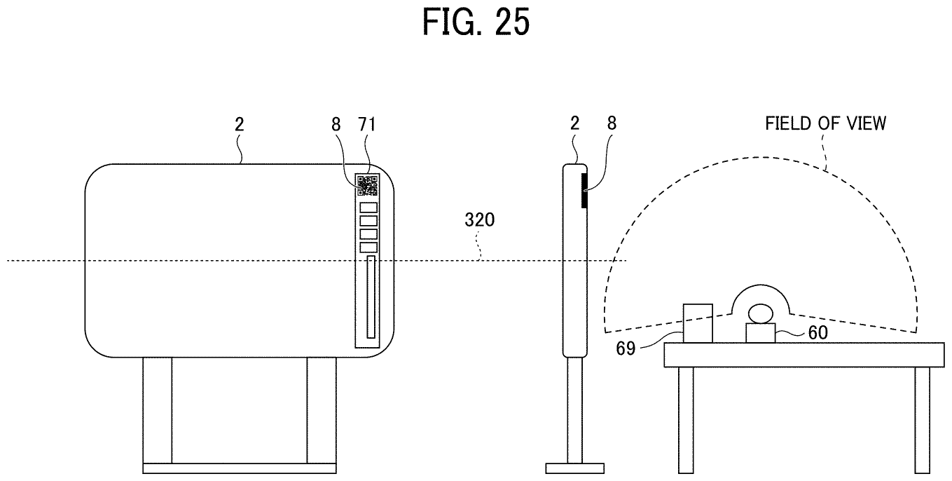

FIG. 25 is a schematic diagram illustrating an example of a method for displaying the two-dimensional code 8 performed by the electronic whiteboard 2 in a case where a camera included in the meeting device 60 is a hemispherical camera according to the present embodiment. By using a hemispherical camera having a wide field of view in the horizontal direction in the configurations illustrated in FIGS. 19 to 24, the two-dimensional code 8 can be found more easily.

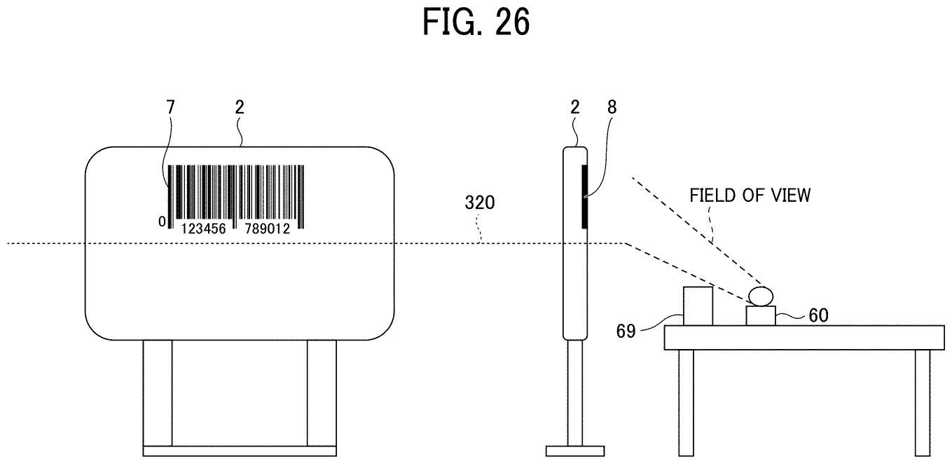

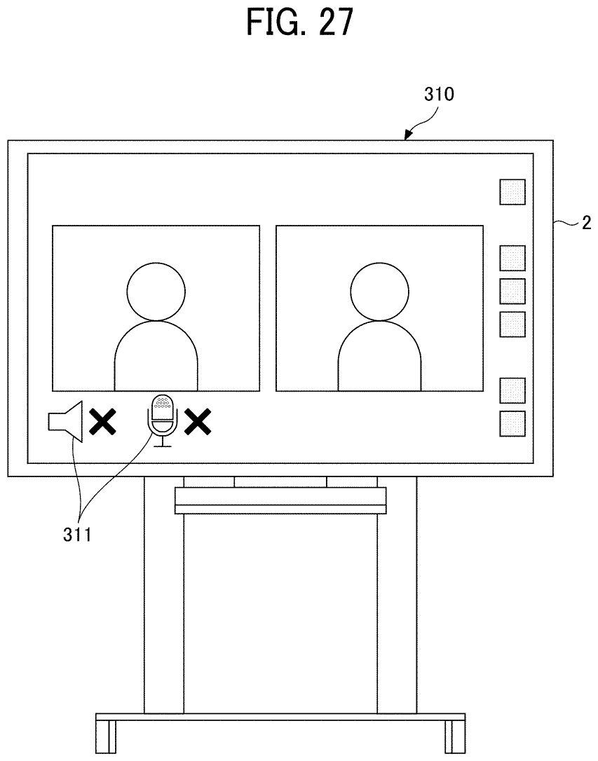

Note that a barcode can be displayed in the same manner as the two-dimensional code 8 is displayed in FIGS. 19 to 25. FIG. 26 is a schematic diagram illustrating an example of a method for displaying a bar code 7 performed by the electronic whiteboard 2 according to the present embodiment.

Note that the bar code 7 is less robust against inclination than the two-dimensional code 8. For this reason, the code analysis unit 22 implemented by the information recording application 41 cuts out a monochrome pattern of the bar code 7 and adjusts a skew angle and a pitch angle of the monochrome pattern. The code analysis unit 22 performs processing of edge enhancement on black bars. The code analysis unit 22 detects the bar code 7 displayed by the electronic whiteboard 2 by performing pattern matching of the cut out image of the monochrome pattern with a pattern from a start character to a stop character at the right end registered as a pattern of the bar code 7.

The examples in which the two-dimensional code 8 or the bar code 7 is displayed have been described with reference to FIGS. 19 to 26. Alternatively, the information recording application 41 may detect, by using optical character recognition (OCR) processing, a device identifier (alphabets or numbers) displayed by the electronic whiteboard 2.

FIG. 27 is a diagram illustrating an example of a screen 310 displayed by the electronic whiteboard 2 in a mute state according to the present embodiment. Mute icons 311 are displayed on the screen 310 as illustrated in FIG. 27. The user can recognize that the electronic whiteboard 2 is currently in a mute state with the mute icons 311.

Muting Procedure 2

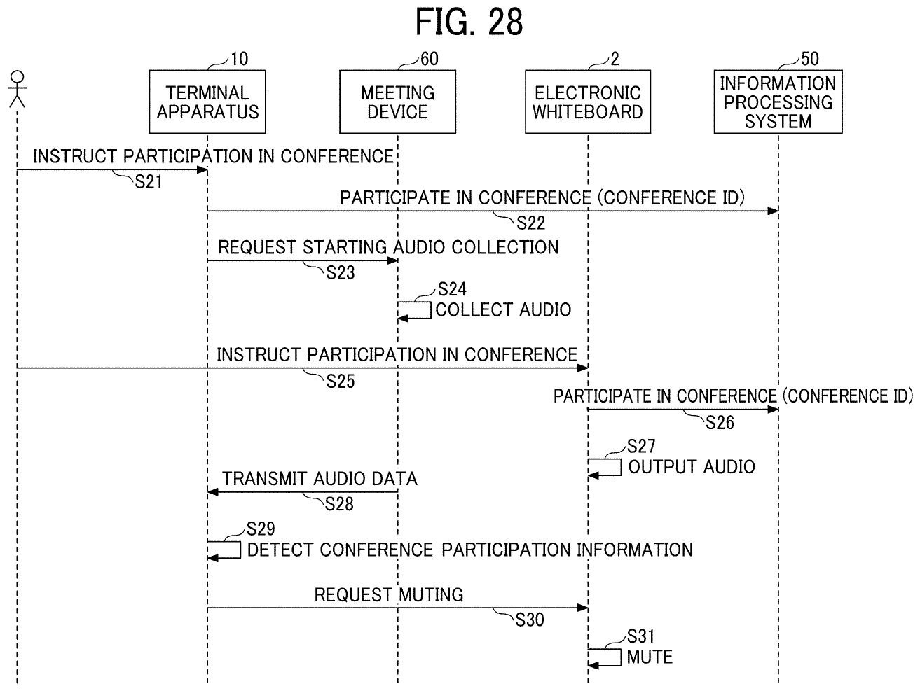

FIG. 28 is a sequence chart illustrating another example of processing executed by the electronic whiteboard 2 to mute audio input and output in response to participation in a conference according to the present embodiments. According to the muting procedure 2, the meeting device 60 detects the electronic whiteboard 2 with an audio signal. In the description referring to FIG. 28, for simplicity, only the main differences from FIG. 16 are described. The processing of participating in the conference in steps S21, S22, S25, and S26 is the same as the processing of steps S1, S2, S5, and S6 illustrated in FIG. 16.

S23: When the terminal apparatus 10 participates in the conference, the terminal apparatus 10 starts processing (device detection processing) for detecting whether there is a device participating in the same conference in which the terminal apparatus 10 participate in the same conference room where the terminal apparatus 10 is located. In this example, the device detection processing is performed with an audio signal. The device communication unit 16 implemented by the information recording application 41 requests the meeting device 60 to start collecting audio.

S24: When the terminal communication unit 61 of the meeting device 60 receives the request to start collecting audio, the audio collection unit 64 of the meeting device 60 repeatedly collects audio.

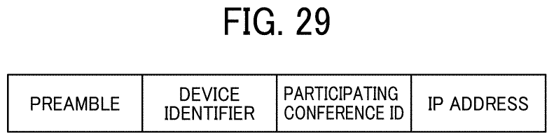

S27: When the electronic whiteboard 2 participates in the conference, the audio data generation unit 37 of the electronic whiteboard 2 generates an audio signal in which conference participation information is included and outputs the audio signal from the speaker 450 of the electronic whiteboard 2. FIG. 29 is a table illustrating an example of a format of an audio signal according to the present embodiment. As illustrated in FIG. 29, the audio signal includes a preamble indicating a head of the audio signal, a device identifier of the electronic whiteboard 2, a conference ID of the conference in which the electronic whiteboard 2 is participating, and the IP address of the electronic whiteboard 2. Although both the device identifier and the IP address are included in the format, either the device identifier or the IP address is enough as a format of an audio signal.

S28: The audio collection unit 64 of the meeting device 60 generates audio data in which the audio signal is included. The terminal communication unit 61 transmits the audio data to the terminal apparatus 10.

S29: When the device communication unit 16 implemented by the information recording application 41 receives the audio data, the audio data analysis unit 24 implemented by the information recording application 41 analyzes the audio data and continuously determines whether the audio data includes information indicating a device to be used in a conference. Alternatively, the processing of step S29 may also be performed by the meeting device 60 instead of the audio data analysis unit 24.

In a case where the information indicating a device to be used in a conference is included in the audio data, the information recording application 41 detects presence of the electronic whiteboard 2. The mute request unit 23 implemented by the information recording application 41 determines whether the electronic whiteboard 2 is participating in the same conference in which the meeting device 60 is participating based on the conference ID included in the audio data. Subsequent processing may be the same as the processing in FIG. 16.

Detecting a device with audio does not require displaying by a display or image capturing by a camera. Accordingly, the electronic whiteboard 2 can detect the meeting device 60 with audio and request the meeting device 60 and the terminal apparatus 10 to be muted. In this case, the roles of the meeting device 60 and the electronic whiteboard 2 are reversed. Alternatively, the electronic whiteboard 2 may mute the electronic whiteboard 2 by itself after detecting the meeting device 60.

Muting Procedure 3

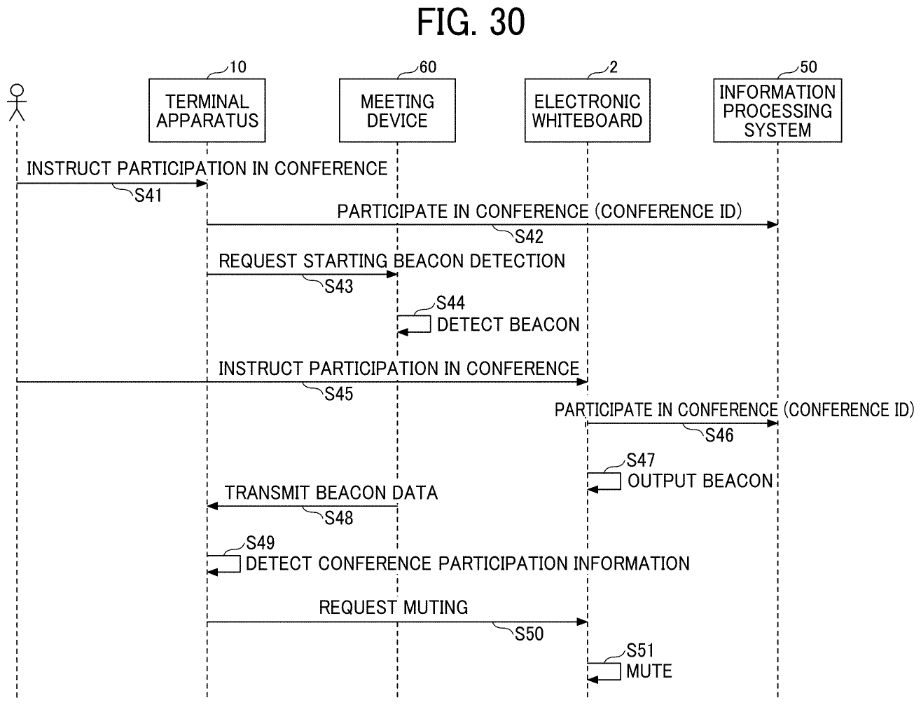

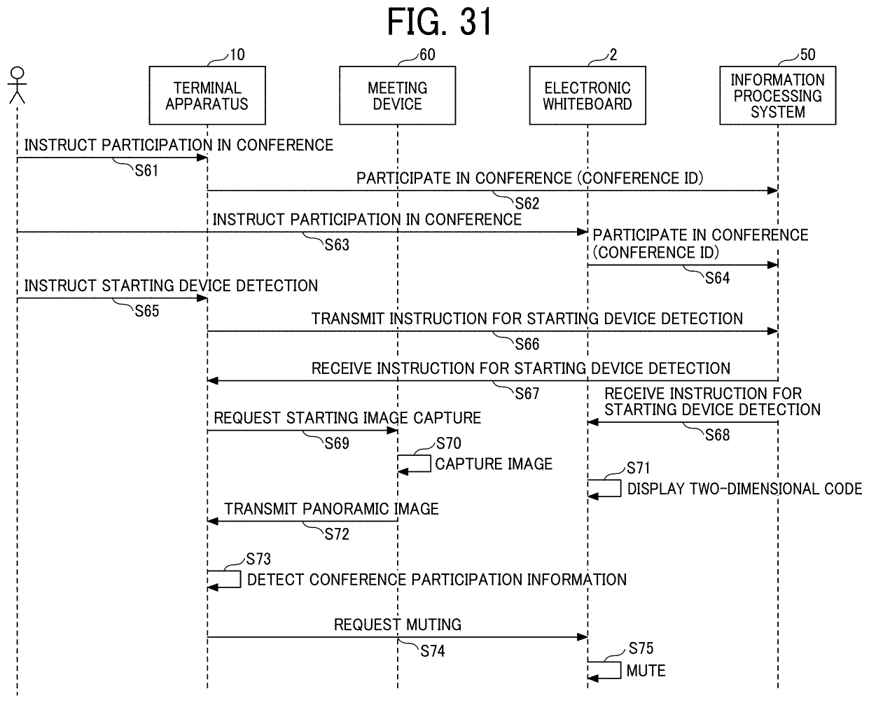

FIG. 30 is a sequence chart illustrating still another example of processing executed by the electronic whiteboard 2 to mute audio input and output in response to participation in a conference according to the present embodiment. According to the muting procedure 3, the meeting device 60 detects the electronic whiteboard 2 with short-range wireless communication. In the description referring to FIG. 30, for simplicity, only the main differences from FIG. 16 are described. The processing of participating in the conference in steps S41, S42, S45, and S46 is the same as the processing of steps S1, S2, S5, and S6 illustrated in FIG. 16.

S43: When the terminal apparatus 10 participates in the conference, the terminal apparatus 10 starts processing (device detection processing) for detecting whether there is a device participating in the same conference in which the terminal apparatus 10 participate in the same conference room where the terminal apparatus 10 is located. In this example, the device detection processing is performed with short-range wireless communication. The device communication unit 16 implemented by the information recording application 41 requests the meeting device 60 to start detecting a beacon.

S44: When the terminal communication unit 61 of the meeting device 60 receives the request to start detecting a beacon, the short-range wireless communication unit 66 of the meeting device 60 repeatedly detects a beacon.

S47: When the electronic whiteboard 2 participates in the conference, the short-range wireless communication unit 38 of the electronic whiteboard 2 generates a beacon in which conference participation information is included and outputs the beacon from an antenna. The format of a signal included in the beacon may be the same as that illustrated in FIG. 29. The beacon refers to a radio wave that includes predetermined information repeatedly transmitted or transmitting the predetermined information repeatedly. Any frequency and communication protocol may be used for the beacon. An example of a frequency and a protocol used for the beacon is a notification packet of BLE.

S48: The short-range wireless communication unit 66 of the meeting device 60 demodulates the beacon to generate beacon data. The terminal communication unit 61 transmits the beacon data to the terminal apparatus 10.

S49. When the device communication unit 16 implemented by the information recording application 41 receives the beacon data, the beacon data analysis unit 25 implemented by the information recording application 41 analyzes the beacon data and continuously determines whether information indicating that the device is a device to be used in the conference is included in the beacon data. Alternatively, the processing of step S49 may also be performed by the meeting device 60 instead of the beacon data analysis unit 25.

In a case where the information indicating a device to be used in a conference is included in the beacon data, the information recording application 41 detects presence of the electronic whiteboard 2. The mute request unit 23 implemented by the information recording application 41 determines whether the electronic whiteboard 2 is participating in the same conference in which the meeting device 60 is participating based on the conference ID included in conference participation information included in the beacon data. Subsequent processing may be the same as the processing in FIG. 16.

Muting Procedure 4

FIG. 31 is a sequence chart illustrating still another example of processing executed by the electronic whiteboard 2 to mute audio input and output in response to participation in a conference according to the present embodiment. According to the muting procedure 4, the device detection processing is started by an instruction from the user. In the description referring to FIG. 31, for simplicity, only the main differences from FIG. 16 are described. The processing of participating in the conference in steps S61 to S64 is the same as the processing of steps S1, S2, S5, and S6 illustrated in FIG. 16. However, each of the terminal apparatus 10 and the electronic whiteboard 2 only participates in the conference in response to receiving an instruction to participate in the conference, and does not automatically perform muting control (detection of the two-dimensional code, display of the two-dimensional code) at the time of participation in the conference.

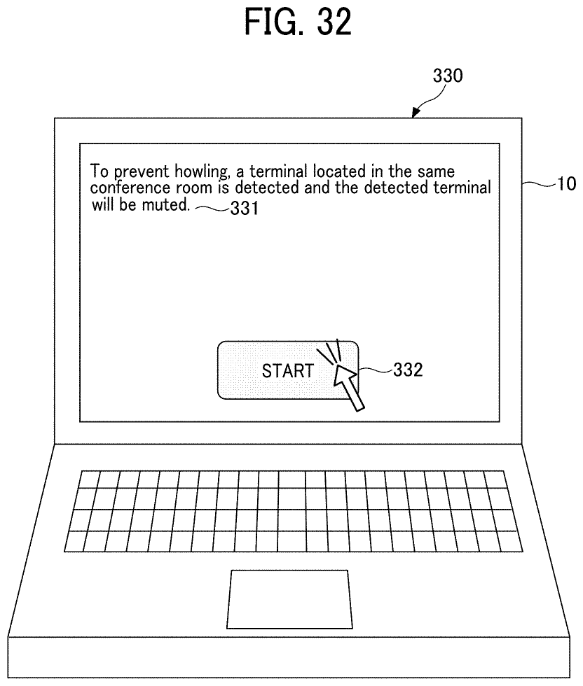

S65: The user instructs the information recording application 41 operating on the terminal apparatus 10 to start the device detection processing. The operation reception unit 12 implemented by the information recording application 41 receives the instruction to start the device detection processing. An example of a screen for starting the device detection processing is illustrated in FIG. 32.

S66: The communication unit 11 implemented by the information recording application 41 transmits a request for starting the device detection processing to the information processing system 50 with designation of the conference ID or the device identifier of the meeting device 60.

S67 and S68: The communication unit 51 of the information processing system 50 receives the request for starting the device detection processing. Accordingly, the device management unit 55 of the information processing system 50 transmits, via the communication unit 51, the request for starting the device detection processing to the meeting device 60 (terminal apparatus 10) participating in the conference, which is identified by the conference ID or the device identifier of the meeting device 60 in the association information, and the electronic whiteboard 2 participating in the conference. Alternatively, the information processing system 50 may transmit the request for starting the device detection processing to the electronic whiteboard 2 in response to polling from the electronic whiteboard 2, or may transmit the request for starting the device detection processing to the electronic whiteboard 2 using bidirectional communication such as WebSocket.

Accordingly, the electronic whiteboard 2 displays the two-dimensional code, and the meeting device 60 captures an image of the two-dimensional code. Subsequent processing of S69 to S75 may be the same as the processing of S3, S4, and S7 to S11 in FIG. 16.

Note that the device detection processing in FIG. 31 can be performed using an audio signal or a beacon as described in the muting procedures 2 and 3 respectively, instead of the two-dimensional code.

FIG. 32 is a diagram illustrating an example of a screen 330 for starting device detection processing displayed by the terminal apparatus 10 according to the present embodiment. The screen 330 for starting device detection processing includes a message 331 indicating “To prevent howling, a terminal located in the same conference room is detected and the detected terminal will be muted.” and a start button 332. The user instructs to start the device detection processing by pressing the start button 332.

According to the muting procedure 4, the meeting device 60 and the electronic whiteboard 2 participating in the conference simultaneously start the device detection processing in response to the instruction form the use. Thus, muting is automatically performed in accordance with the device detection processing even if individual devices participate in the conference at greatly different timings from each other. For example, even when the user instructs the electronic whiteboard 2 to participate in a conference first and instructs the meeting device 60 to participate in the conference several minutes later, the electronic whiteboard 2 can be muted. Further, since the device detection processing is performed based on the user's instruction, unnecessary device detection processing can be prevented.

Muting Procedure 5

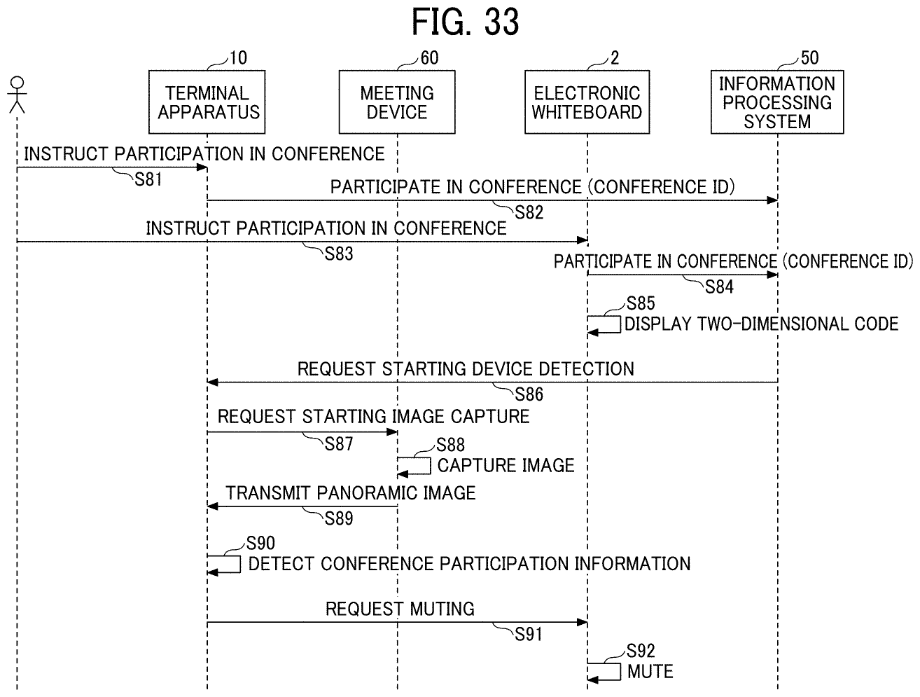

FIG. 33 is a sequence chart illustrating still another example of processing executed by the electronic whiteboard 2 to mute audio input and output in response to participation in a conference according to the present embodiment. According to the muting procedure 5, the device detection processing is started at the timing at which the electronic whiteboard 2 participates in the conference. In the description referring to FIG. 33, for simplicity, only the main differences from FIG. 16 are described. The processing of participating in the conference in steps S81 to S84 is the same as the processing of steps S1, S2, S5, and S6 illustrated in FIG. 16. However, the terminal apparatus 10 only participates in the conference in response to receiving an instruction to participate in the conference, and does not perform muting control (detection of the two-dimensional code) at the time of participation in the conference.

S85: When the electronic whiteboard 2 participates in the conference in response to an instruction to participate in the conference, the display control unit 34 of the electronic whiteboard 2 displays a two-dimensional code including conference participation information.

S86: When the meeting device 60 and the electronic whiteboard 2 participate in the conference, the device management unit 55 of the information processing system 50 transmits a request to start acquiring a two-dimensional code (a request for starting device detection processing) to the terminal apparatus 10 via the communication unit 51 of the information processing system 50.

S87: When the communication unit 11 implemented by the information recording application 41 receives a request for starting device detection processing, the device communication unit 16 implemented by the information recording application 41 requests the meeting device 60 to start capturing a panoramic image. Since the electronic whiteboard 2 is displaying the two-dimensional code, the terminal apparatus 10 detects the electronic whiteboard 2. Subsequent processing of S88 to S92 may be the same as the processing of S4 and S8 to S11 in FIG. 16.

Note that the device detection processing in FIG. 33 can be performed using an audio signal or a beacon as described in the muting procedures 2 and 3 respectively, instead of the two-dimensional code.

The meeting device 60 participates in the conference first in FIG. 33. Alternatively, the electronic whiteboard 2 may participate in the conference first. In this case, the electronic whiteboard 2 displays the two-dimensional code after receiving a notification indicating participation of the meeting device 60 in the conference from the information processing system 50.

According to the muting procedure 5, the device detection processing is performed as appropriate every time another device participates in the conference. Thus, muting is automatically performed without being affected by the timing of participation of each device in the conference and without requiring an instruction from the user.

Muting Procedure 6

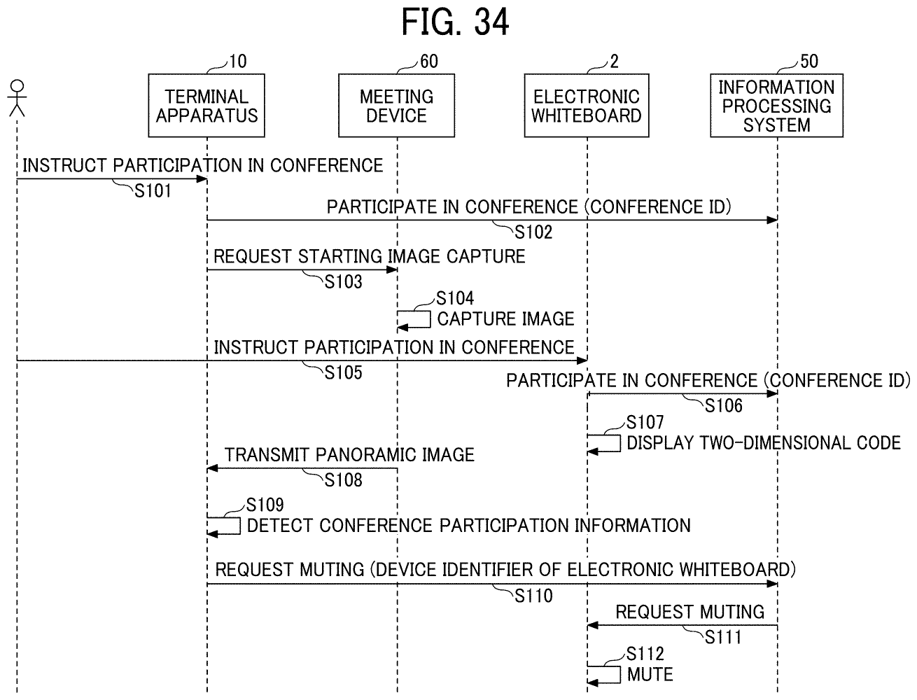

FIG. 34 is a sequence chart illustrating still another example of processing executed by the electronic whiteboard 2 to mute audio input and output in response to participation in a conference according to the present embodiment. According to the muting procedure 6, the terminal apparatus 10 does not transmit a request for muting directly to the electronic whiteboard 2, but transmits the request for muting to the electronic whiteboard 2 via the information processing system 50. In the description referring to FIG. 34, for simplicity, only the main differences from FIG. 16 are described. The processing of steps S101 to S109 is the same as the processing of steps S1 to S9 illustrated in FIG. 16.

S110: When the code analysis unit 22 implemented by the information recording application 41 detects the electronic whiteboard 2, the mute request unit 23 implemented by the information recording application 41 requests the information processing system 50 to mute the electronic whiteboard 2 via the communication unit 11 implemented by the information recording application 41. The request for muting includes the device identifier of the electronic whiteboard 2 for allowing the information processing system 50 to communicate with the electronic whiteboard 2.

S111: In response to receiving the request for muting, the communication unit 51 of the information processing system 50 transmits the request for muting to the electronic whiteboard 2 identified by the device identifier. For example, it is assumed that the electronic whiteboard 2 repeatedly performs polling with designation of the device identifier after participating in the conference. The information processing system 50 transmits the request for muting to the electronic whiteboard 2 as a response to the polling. Alternatively, for example, it is assumed that the electronic whiteboard 2 and the information processing system 50 communicate with each other (the device identifier of the electronic whiteboard 2 is transmitted) using bidirectional communication such as WebSocket after the electronic whiteboard 2 participates in the conference. The information processing system 50 transmits the request for muting to the electronic whiteboard 2 identified by the device identifier.

S112: When the communication unit 36 of the electronic whiteboard 2 receives the request for muting, the adjustment unit 39 of the electronic whiteboard 2 mutes at least one of the microphone 440 and the speaker 450.

Note that the device detection processing in FIG. 34 can be performed using an audio signal or a beacon as described in the muting procedures 2 and 3 respectively, instead of the two-dimensional code.

According to the muting procedure 6, the terminal apparatus 10 requests the electronic whiteboard 2 to be muted via the information processing system 50. Thus, the terminal apparatus 10 can transmit the request for muting to the electronic whiteboard 2 even in an environment where the terminal apparatus 10 and the electronic whiteboard 2 cannot directly communicate with each other.

Muting Procedure 7

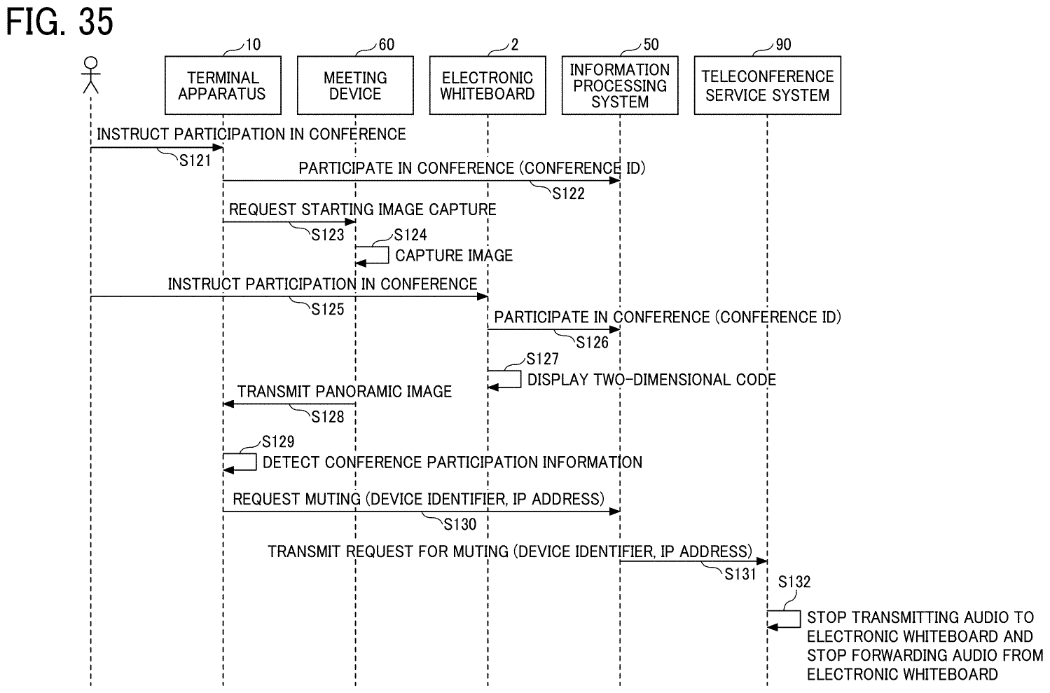

FIG. 35 is a sequence chart illustrating still another example of processing executed by the electronic whiteboard 2 to mute audio input and output in response to participation in a conference according to the present embodiment. According to the muting procedure 7, instead of muting at least one of the microphone 440 and the speaker 450 of the electronic whiteboard 2, the teleconference service system 90 stops audio transmission and reception to and from the electronic whiteboard 2. In the description referring to FIG. 35, for simplicity, only the main differences from FIG. 16 are described. The processing of steps S121 to S129 is the same as the processing of steps S1 to S9 illustrated in FIG. 16.

S130: When the code analysis unit 22 implemented by the information recording application 41 detects the electronic whiteboard 2, the mute request unit 23 implemented by the information recording application 41 requests the information processing system 50 to mute the electronic whiteboard 2 via the communication unit 11 implemented by the information recording application 41. The request for muting includes the device identifier or the IP address of the electronic whiteboard 2.

S131: In response to receiving the request for muting, the communication unit 51 of the information processing system 50 transmits the request for muting to the teleconference service system 90 with designation of the device identifier or the IP address of the electronic whiteboard 2.

S132: The teleconference service system 90 stops audio transmission output from another site to the electronic whiteboard 2 identified by the device identifier or the IP address of the electronic whiteboard 2 and stops audio transmission output from the electronic whiteboard 2 to the other site. This results in the same state in which the electronic whiteboard 2 is muted.

Note that the device detection processing in FIG. 35 can be performed using an audio signal or a beacon as described in the muting procedures 2 and 3 respectively, instead of the two-dimensional code.

According to the muting procedure 7, the teleconference service system 90 sets the electronic whiteboard 2 in the mute state. Thus, there is no need to change the device settings of the electronic whiteboard 2.

Muting Procedure 8

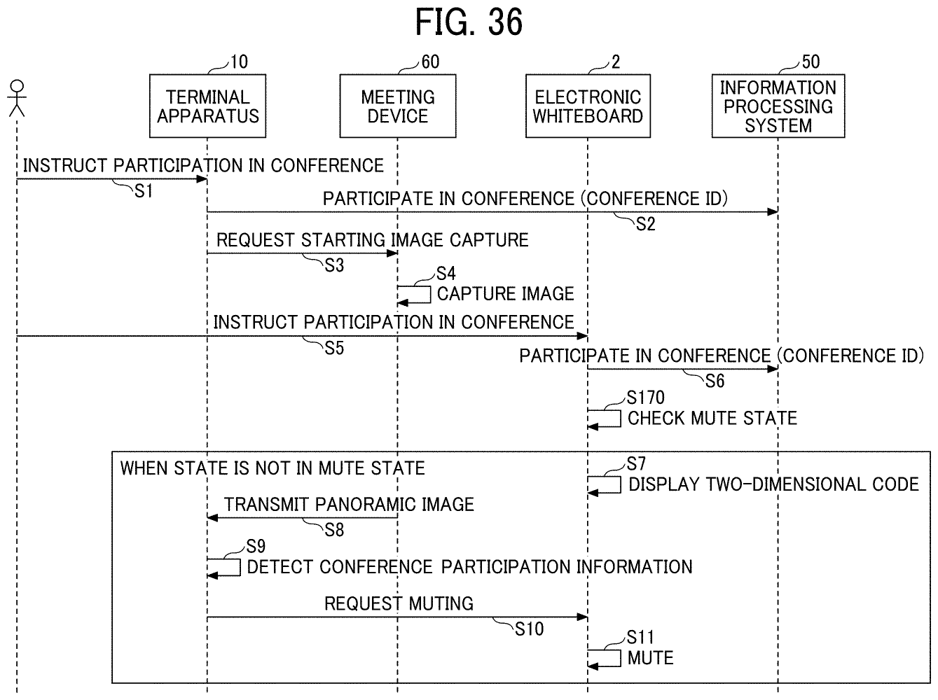

FIG. 36 is a sequence chart illustrating still another example of processing executed by the electronic whiteboard 2 to mute audio input and output in response to participation in a conference according to the present embodiment. According to the muting procedure 8, in a case where the electronic whiteboard 2 is already in the mute state at the start of the conference, the device detection processing is not performed. In the description referring to FIG. 36, for simplicity, only the main differences from FIG. 16 are described. The processing of steps S1 to S6 is the same as the processing of steps S1 to S6 illustrated in FIG. 16.

S170: When the communication unit 36 of the electronic whiteboard 2 transmits a notification of participation in the conference to the information processing system 50, the adjustment unit 39 of the electronic whiteboard 2 determines whether the adjustment unit 39 itself is in the mute state (adjusted state).

In a case where the adjustment unit 39 is already in the adjusted state, the display control unit 34 of the electronic whiteboard 2 does not display the two-dimensional code. Only in a case where the adjustment unit 39 is not in the adjusted state, the display control unit 34 displays the two-dimensional code and processing same as the processing of the muting procedure 1 is performed. Note that the terminal apparatus 10 may continue capturing an image using the meeting device 60 in order to capture images of the participants in addition to the two-dimensional code. Alternatively, the terminal apparatus 10 may stop capturing an image using the meeting device 60 in a certain time after the participation in the conference.

Note that the device detection processing in FIG. 36 can be performed using an audio signal or a beacon as described in the muting procedures 2 and 3 respectively, instead of the two-dimensional code.

According to the muting procedure 8, when the electronic whiteboard 2 is already in the mute state at the time of participation in the conference, unnecessary processing can be prevented from being executed.

Unmuting Procedure

Descriptions are given below of several unmuting procedures.

Unmuting Procedure 1

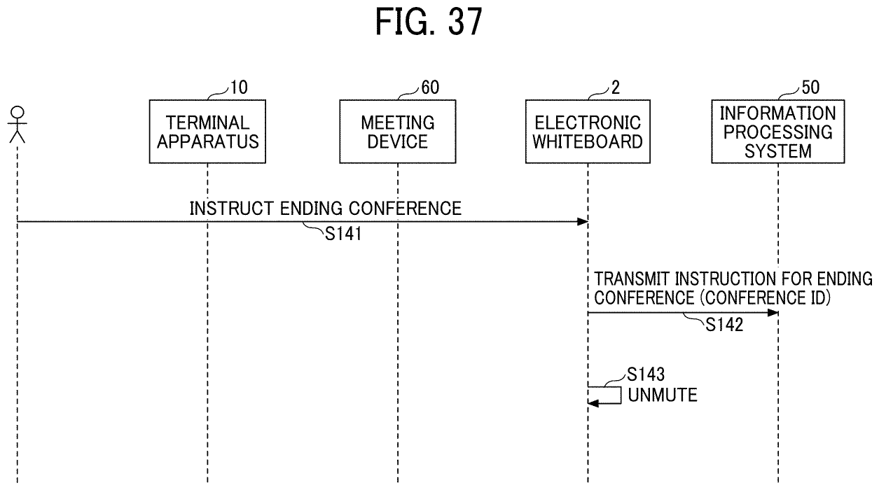

FIG. 37 is a sequence chart illustrating an example of processing of the electronic whiteboard 2 to be unmuted when exiting from a conference according to the present embodiment. When the electronic whiteboard 2 exits from the conference, object data displayed by the electronic whiteboard 2 is not shared with other sites and is not recorded. In the example illustrated in FIG. 37, at least one of the microphone 440 and the speaker 450 is in a mute state when the electronic whiteboard 2 participates in the conference.

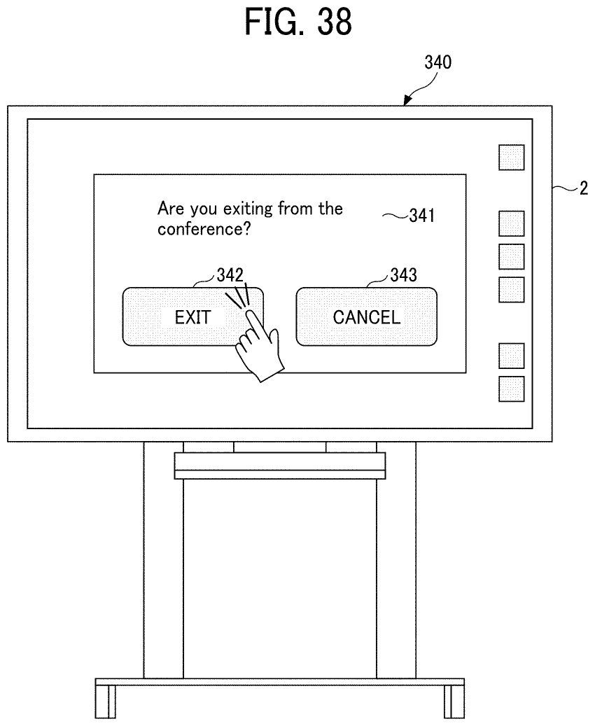

S141: The user instructs the electronic whiteboard 2 to exit from the conference. The operation reception unit 12 implemented by the information recording application 41 receives the instruction to exit from the conference. An example of a screen for exiting from a conference is illustrated in FIG. 38.

S142: In response to the instruction from the user, the communication unit 36 of the electronic whiteboard 2 transmits a notification indicating an end of the conference (an exit from the conference) to the information processing system 50 with designation of the conference ID. When the communication unit 51 of the information processing system 50 receives the notification indicating the end of the conference, the device management unit 55 of the information processing system 50 deletes the association information identified by the conference ID.

S143: In response to the instruction to end the conference from the user, the adjustment unit 39 of the electronic whiteboard 2 cancels the mute state and resets the volume setting to the state before participation in the conference.

With respect to the terminal apparatus 10, the user separately operates the terminal apparatus 10 to end the conference. Accordingly, the device management unit 55 deletes the device identifier of the meeting device 60 from the association information. With respect to the terminal apparatus 10, processing relating to muting does not occur.

FIG. 38 is a diagram illustrating an example of a screen 340 for instructing an exit from a conference displayed by the electronic whiteboard 2 according to the present embodiment. The screen 340 for instructing an exit from a conference includes a message 341 indicating “Are you exiting from the conference?”, an exit button 342, and a cancel button 343. The user instructs the electronic whiteboard 2 to exit from the conference by pressing the exit button 342.

According to the unmuting procedure 1, the electronic whiteboard 2 that has been muted at the time of participation in the conference is prevented from being left muted against the intention of the user. Note that the unmuting procedure 1 is applicable to any one of the above-describe muting procedures regardless of the method of muting except for the muting procedure 7.

Unmuting Procedure 2

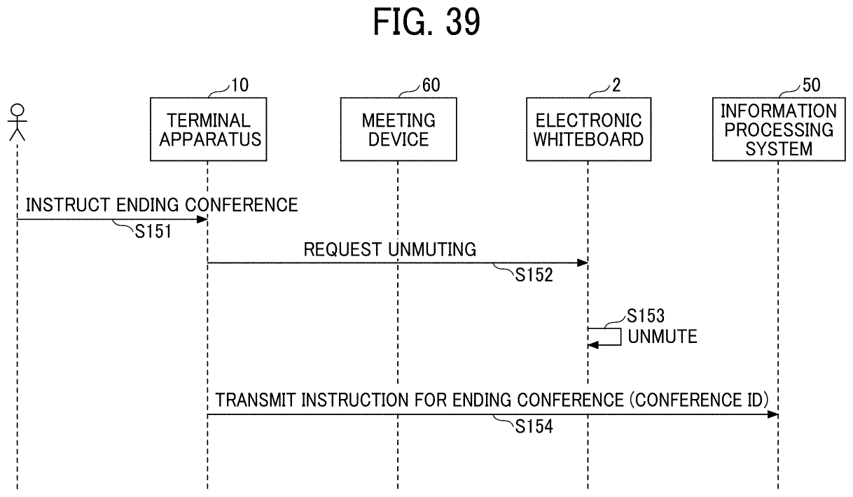

FIG. 39 is a sequence chart illustrating another example of processing of the electronic whiteboard 2 to be unmuted when the terminal apparatus 10 exits from a conference according to the present embodiment. In the example illustrated in FIG. 39, it is assumed that the terminal apparatus 10 sets the electronic whiteboard 2 in the mute state at the time of participation in the conference.

S151: The user instructs the information recording application 41 to exit from the conference. The operation reception unit 12 implemented by the information recording application 41 receives the instruction to exit from the conference.

S152: The communication unit 11 implemented by the information recording application 41 transmits a request to cancel the mute state to the electronic whiteboard 2 using the IP address of the electronic whiteboard 2 as a destination.

S153: When the communication unit 36 of the electronic whiteboard 2 receives the request to cancel the mute state, the adjustment unit 39 of the electronic whiteboard 2 cancels the mute state and resets the volume setting to the state before participation in the conference.

S154: The communication unit 11 implemented by the information recording application 41 transmits a notification indicating an end of the conference (an exit from the conference) to the information processing system 50 with designation of the conference ID. The communication unit 51 of the information processing system 50 deletes the association information (the device identifiers of the meeting device 60 and the electronic whiteboard 2) identified by the conference ID.

In the example of FIG. 39, the terminal apparatus 10 transmits the instruction to cancel the mute state directly to the electronic whiteboard 2. Alternatively, in a case where the terminal apparatus 10 sets the electronic whiteboard 2 in the mute state via the information processing system 50, the terminal apparatus 10 may transmit the instruction to cancel the mute state to the electronic whiteboard 2 via the information processing system 50.

According to the unmuting procedure 2, in a case where the terminal apparatus 10 exits from the conference before the electronic whiteboard 2 exits from the conference, it is possible to prevent the discontinuation of the conference resulting from continuation of muting of the electronic whiteboard 2. In addition, it is advantageous that the user only needs to instruct the terminal apparatus 10 to exit from the conference. Note that the unmuting procedure 2 is applicable to any one of the above-describe muting procedures regardless of the method of muting.

Unmuting Procedure 3

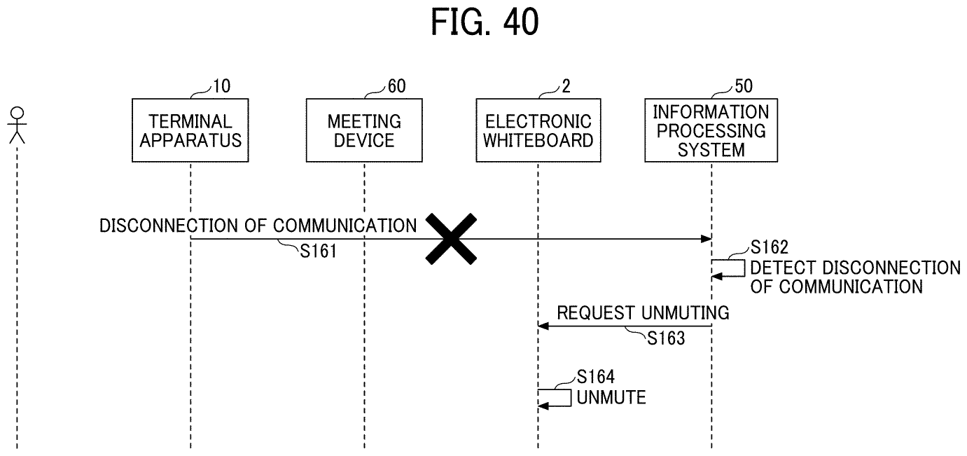

FIG. 40 is a sequence chart illustrating an example of processing of the electronic whiteboard 2 to be unmuted in a case where communication between the terminal apparatus and the information processing system 50 is disconnected according to the present embodiment. In the example illustrated in FIG. 40, it is assumed that the terminal apparatus sets the electronic whiteboard 2 in the mute state at the time of participation in the conference.

S161 and S162: The communication unit 51 of the information processing system 50 monitors communication with the terminal apparatus 10 (for example, transmits a packet internet groper (PING) command) while the conference is held. In a case where a disconnection of communication occurs due to a network connection failure or the like, the information processing system 50 detects the disconnection of communication with the terminal apparatus 10. Note that the disconnection of communication includes shutting down or freezing of the terminal apparatus 10.

S163: When the disconnection of communication is detected, the device management unit 55 of the information processing system 50 transmits a request to cancel the muting state to the electronic whiteboard 2 that has entered the mute state according to the instruction from the terminal apparatus 10. The electronic whiteboard 2 to be unmuted is the electronic whiteboard 2 that has transmitted the request for participation in the conference. The information processing system 50 stores the device identifier and the IP address of the electronic whiteboard 2 that has transmitted the request for participation in the conference.

S164: When the communication unit 36 of the electronic whiteboard 2 receives the request to cancel the mute state, the adjustment unit 39 of the electronic whiteboard 2 cancels the mute state and resets the volume setting to the state before participation in the conference.

According to the unmuting procedure 3, in a case where communication with the terminal apparatus 10 is disconnected, it is possible to prevent the discontinuation of the conference resulting from continuation of muting of the electronic whiteboard 2. Note that the unmuting procedure 3 is applicable to any one of the above-describe muting procedures regardless of the method of muting.

Termination of Device Detection Processing in Electronic Whiteboard 2

According to the muting procedure 1 and the like, even in the case where the mute request is not transmitted to the electronic whiteboard 2, the electronic whiteboard 2 stops displaying the two-dimensional code after a certain period of time elapses from the start of displaying the two-dimensional code. Accordingly, in a case where the electronic whiteboard 2 does not receive the mute request, there is an inconvenience that the two-dimensional code may remain displayed for the certain period of time. For this reason, the electronic whiteboard 2 stops displaying the two-dimensional code when the user starts using the electronic whiteboard 2, not when the certain period of time elapses.

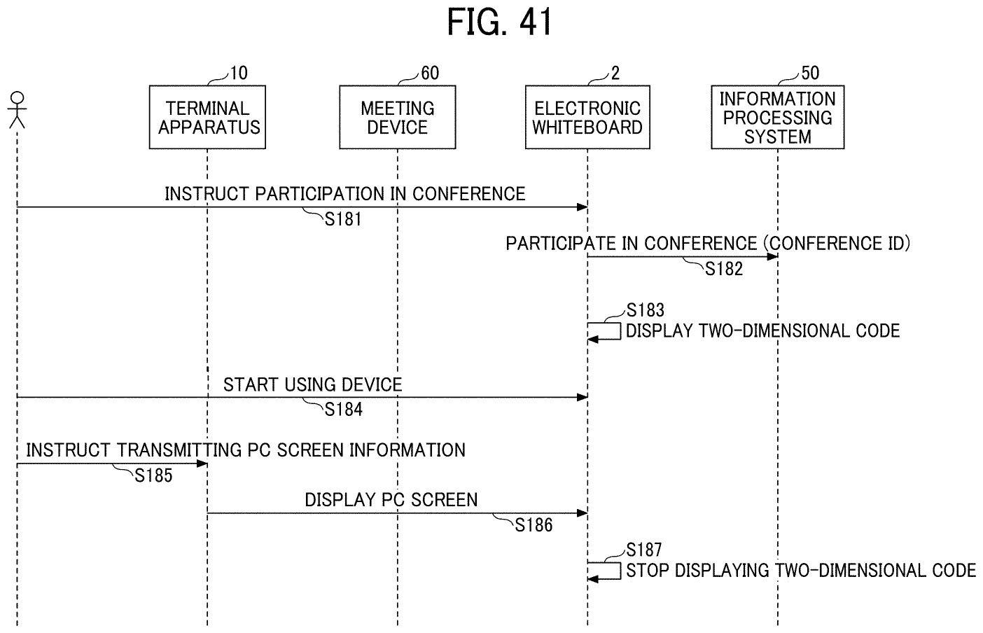

FIG. 41 is a sequence chart illustrating an example of processing executed by the electronic whiteboard 2 to stop displaying a two-dimensional code without receiving a muting request after the electronic whiteboard is activated according to the present embodiment. The processing of steps S181 to S183 is the same as the processing of steps S5 to S7 illustrated in FIG. 16.

S184: The user starts using the electronic whiteboard 2. An example of a method for determining the start of use is touching the screen of the electronic whiteboard 2 with a hand or an electronic pen.

S185: Another example of the method for determining the start of use is displaying a screen of the terminal apparatus 10 on the electronic whiteboard 2 according to an instruction from the terminal apparatus 10. Note that the methods for determining the start of use are not limited thereto.

S186: The terminal apparatus 10 transmits screen information representing the screen to the electronic whiteboard 2 via an HDMI cable or the like.

S187: When the display control unit 34 of the electronic whiteboard 2 detects the start of use, the display control unit 34 stops displaying the two-dimensional code even before the certain period of time elapses. In this case, the meeting device 60 and the electronic whiteboard 2 are not associated with each other. However, as illustrated in FIG. 31, in the case where the information processing system 50 starts the device detection processing at the time of the participation of the terminal apparatus 10 in the conference, the electronic whiteboard 2 again displays the two-dimensional code. Thus, the meeting device 60 and the electronic whiteboard 2 are associated with each other.

Note that even in a case where the device detection processing is performed using an audio signal or a beacon as described in the muting procedures 2 and 3 respectively, instead of the two-dimensional code, the device detection processing can be terminated in substantially the same manner as the processing illustrated in FIG. 41.

In the processing illustrated in FIG. 41, the device detection processing is terminated at the timing when the user starts using the electronic whiteboard 2. Thus, for example, the two-dimensional code is prevented from interfering with the conference.

Recording in A Conference

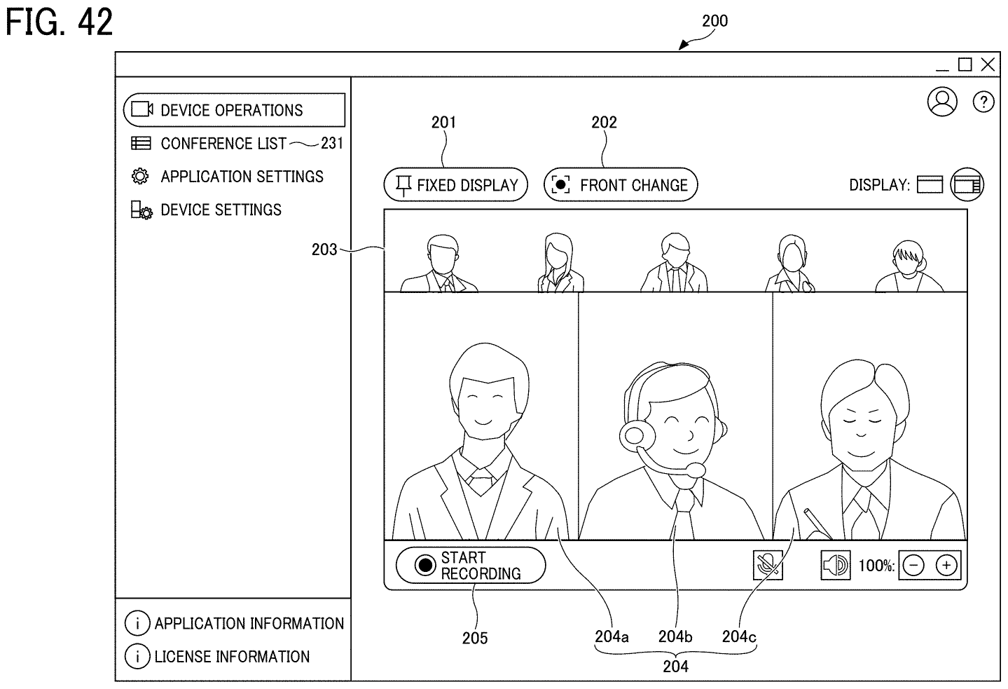

Descriptions are now given of several screens displayed by the terminal apparatus 10 in a teleconference with reference to FIGS. 42 to 45. FIG. 42 is a diagram illustrating an example of an initial screen 200 displayed by the information recording application 41 operating on the terminal apparatus 10 after a login according to the present embodiment. The user operates the terminal apparatus 10 to connect the information recording application 41 to the information processing system 50. The user inputs authentication information, and if the login is successful, the initial screen 200 of FIG. 42 is displayed.

The initial screen 200 includes a fixed display button 201, a front change button 202, the panoramic image 203, one or more talker images 204a to 204c, and a start recording button 205. Hereinafter, the talker images 204a to 204c are collectively referred to as “talker images 204,” and one thereof is referred to as the “talker image 204.” In a case where the meeting device 60 is already activated and is capturing an image of the surroundings at the time of the login, the panoramic image 203 and the talker images 204 generated by the meeting device 60 are displayed on the initial screen 200. Accordingly, the user can decide whether to start recording while viewing the panoramic image 203 and the talker images 204. In a case where the meeting device 60 is not activated (is not capturing any image), neither the panoramic image 203 nor the talker images 204 are displayed.

The information recording application 41 may display the talker images 204 of all participants based on all faces detected in the panoramic image 203. Alternatively, the information recording application 41 may display the talker images 204 of N-number of persons who have most recently spoken. In the example illustrated in FIG. 42, the talker images 204 of up to three persons are displayed. Display of the talker image 204 of a participant may be omitted until one of the participants speaks. In this case, the number of the talker images 204 increases by one in response to speech. Alternatively, the talker images 204 of three participants in a predetermined direction may be displayed. In this case, the talker images 204 are switched in response to speech.

When no participant is speaking such as immediately after the meeting device 60 is activated, an image of a predetermined direction (such as 0 degrees, 120 degrees, or 240 degrees) of 360 degrees in the horizontal direction is generated as the talker image 204. In a case where fixed display to be described later is set, the setting of the fixed display is prioritized.

The fixed display button 201 is a button that allow the user to perform an operation of fixing a certain area of the panoramic image 203 as the talker image 204 in close-up.

The front change button 202 is a button that allows the user to perform an operation of changing the front of the panoramic image 203. Since the panoramic image presents an image of surroundings in 360 degrees in the horizontal direction, the right end and the left end indicated by the user correspond to the right end and the left end in the panoramic image 203 respectively. The user slides the panoramic image 203 leftward or rightward with a pointing device to set a particular participant to the front. The operation performed by the user is transmitted to the meeting device 60. The meeting device 60 changes the angle set as the front in 360 degrees in the horizontal direction, generates the panoramic image 203 at the changed angle, and transmits the panoramic image 203 to the terminal apparatus 10.

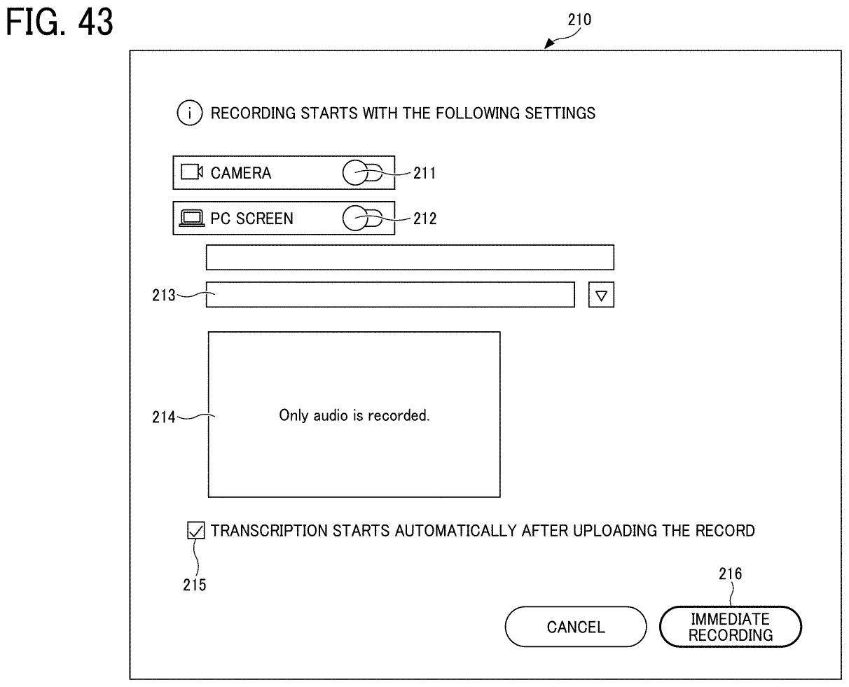

When the user presses the start recording button 205, the information recording application 41 displays a recording setting screen 210 illustrated in FIG. 43.

FIG. 43 is a diagram illustrating an example of the record setting screen 210 displayed by the information recording application 41 according to the present embodiment. The recording setting screen 210 allows the user to set the information recording application 41 whether to record (whether to include in recording) the panoramic image 203 and the talker images 204 generated by the meeting device 60 and the desktop screen of the terminal apparatus 10 or the screen of the application operating on the terminal apparatus 10. In a case where the information recording application 41 is set to record none of the panoramic image, the talker images, and the desktop screen or the screen of the operating application, the information recording application 41 records only audio (audio output by the terminal apparatus 10 and audio collected by the meeting device 60).

A camera toggle button 211 is a button for switching on and off of recording of the panoramic image 203 and the talker images 204 generated by the meeting device 60. Alternatively, the camera toggle button 211 may allow settings for switching on and off of recording of the panoramic image 203 and the talker images 204 individually.

A PC screen toggle button 212 is a button for switching on and off of recording of the desktop screen of the terminal apparatus 10 or a screen of an application operating on the terminal apparatus 10. In a case where the PC screen toggle button 212 is on, the desktop screen is recorded.

When the user desires to record a screen of an application, the user further selects the application in an application selection field 213. In the application selection field 213, names of applications operating on the terminal apparatus 10 are displayed in a pull-down format. Thus, the user can select an application to be recorded. The information recording application 41 acquires the names of the applications from the OS. The information recording application 41 can display names of applications that have a user interface (screen) among applications operating on the terminal apparatus 10. The teleconference application 42 may be included in the applications to be selected. Thus, the information recording application 41 can record materials displayed by the teleconference application 42 and participants at each site in a moving image. In addition, names of various applications operating on the terminal apparatus 10, such as a presentation application, a word processing application, a spreadsheet application, a document application for creating and editing a material, an electronic whiteboard application in a cloud service, and a web browser application, are displayed in the application selection field 213 in the pull-down format. Thus, the user can flexibly select a screen of an application to be included in a composite moving image.

When recording is performed in units of applications, the user is allowed to select a plurality of applications. The information recording application 41 can record the screens of all the applications selected by the user.

When both the camera toggle button 211 and the PC screen toggle button 212 are set to off, a message “Only audio is recorded” is displayed in a recording content confirmation window 214. The audio in this case includes audio output from the terminal apparatus 10 (audio received by the teleconference application 42 from the other site 101) and audio collected by the meeting device 60. In other words, when a teleconference is being held, the audio of the teleconference application 42 and the audio of the meeting device 60 are recorded regardless of whether or not the images are recorded. The user settings may be set such that the user can selectively stop recording the audio of the teleconference application 42 and the audio of the meeting device 60.

In accordance with a combination of on and off of the camera toggle button 211 and the PC screen toggle button 212, the composite moving image is recorded in the following manner. Further, the composite moving image is displayed in real time in the recording content confirmation window 214.

In a case where the camera toggle button 211 is on and the PC screen toggle button 212 is off, the panoramic image and the talker images captured by the meeting device 60 are displayed in the recording content confirmation window 214.

In a case where the camera toggle button 211 is off and the PC screen toggle button 212 is on (and the screen has also been selected), the desktop screen or the screen of the selected application is displayed in the recording content confirmation window 214.

In a case where the camera toggle button 211 is on and the PC screen toggle button 212 is on, the panoramic image and the talker images captured by the meeting device 60 and the desktop screen or the screen of the selected application are displayed side by side in the recording content confirmation window 214.

Accordingly, there is a case where the panoramic image and the talker image or the screen of the application is not recorded or a case where none of the panoramic image, the talker image, and the screen of the application are recorded. However, in the present embodiment, an image generated by the information recording application 41 is referred to as a composite moving image for the sake of explanatory convenience.

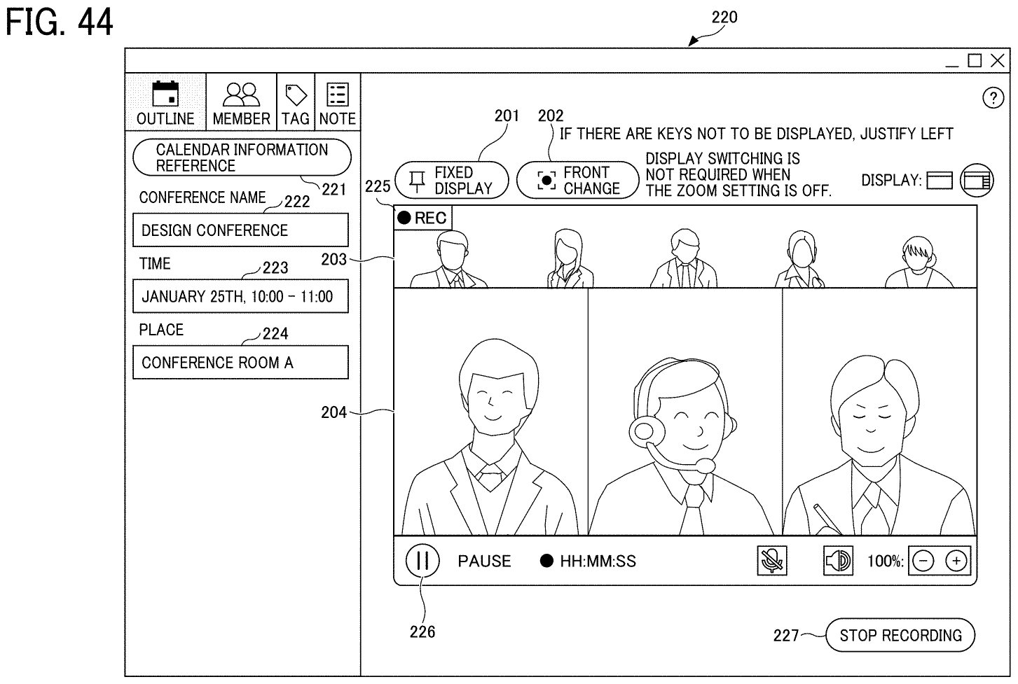

The recording setting screen 210 further includes a check box 215 with a message “Transcription starts automatically after uploading the record.” The recording setting screen 210 further includes an immediate recording button 216. If the user ticks the check box 215, text data converted from the speech in the teleconference is attached to the recorded moving image. In this case, after the end of recording, the information recording application 41 uploads audio data to the information processing system 50 together with a request for converting the audio data into text data. When the user presses the immediate recording button 216, a recording screen 220 is displayed as illustrated in FIG. 44.

FIG. 44 is a diagram illustrating an example of the recording screen 220 displayed by the information recording application 41 during recording according to the present embodiment. In the description referring to FIG. 44, for simplicity, only the main differences from FIG. 42 are described. On the recording screen 220, a composite moving image recorded according to the conditions set by the user on the recording setting screen 210 is displayed in real time. The recording screen 220 of FIG. 44 corresponds to the case where the camera toggle button 211 is on and the PC screen toggle button 212 is off. In such a case, the panoramic image 203 and the talker images 204 (both are moving images) generated by the meeting device 60 are displayed on the recording screen 220. On the recording screen 220, a recording icon 225, a pause button 226, and a stop recording button 227 are displayed.

The pause button 226 is a button for pausing the recording. The pause button 226 also receives an operation of resuming the recording after the recording is paused. The stop recording button 227 is a button for ending the recording. The recording ID does not change when the pause button 226 is pressed, whereas the recording ID changes when the stop recording button 227 is pressed. After pausing or temporarily stopping the recording, the user can set the recording conditions set on the recording setting screen 210 again before resuming the recording or starting recording again. In this case, the information recording application 41 may generate a plurality of recorded files each time the recording is stopped (e.g., when the stop recording button 227 is pressed), or may consecutively connect the plurality of recorded files to generate a single moving image (e.g., when the pause button 226 is pressed). Alternatively, when the information recording application 41 replays the composite moving image, the information recording application may consecutively replay the plurality of recorded files as a single moving image.

The recording screen 220 includes a calendar information reference button 221, a conference name field 222, a time field 223, and a place field 224. The calendar information reference button 221 is a button that allows the user to acquire conference information from the conference management system 9. When the user presses the calendar information reference button 221, the information recording application 41 acquires a list of conferences for which the user has a viewing authority from the information processing system 50 and displays the acquired list of conferences. The user selects a teleconference to be held at that time from the list of conferences. Consequently, the conference information is reflected in the conference name field 222, the time field 223, and the place field 224. The title, the start time and the end time, and the place included in the conference information are reflected in the conference name field 222, the time field 223, and the place field 224, respectively. In addition, the conference information in the conference management system 9 and the record of conference are associated with each other by the conference ID.

When the teleconference ends and the user ends the recording, a composite moving image with audio is generated.

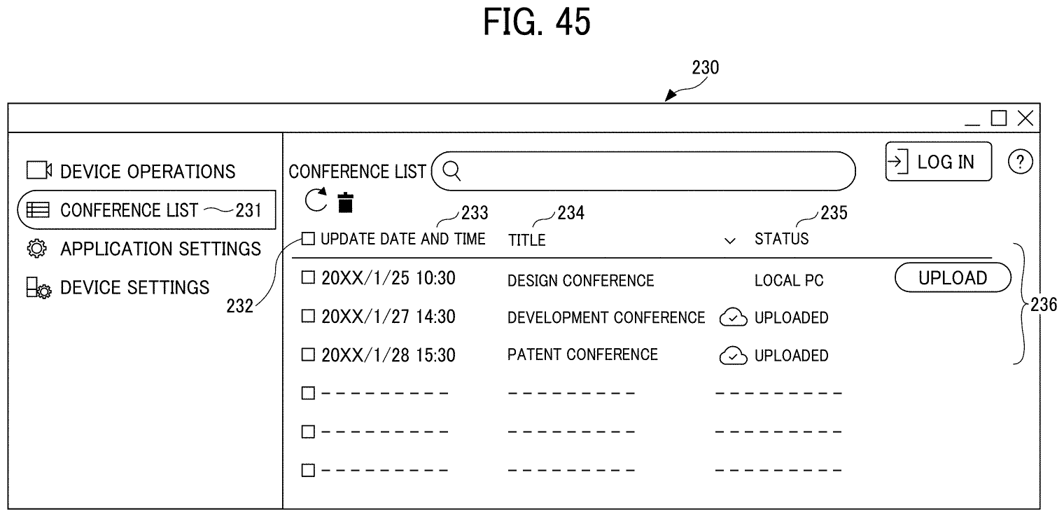

FIG. 45 is a diagram illustrating an example of a conference list screen 230 displayed by the information recording application 41 according to the present embodiment. On the conference list screen 230, a list of conferences, specifically, a list of the records of conference recorded in the teleconferences is displayed. The list of conferences includes conferences held in a certain conference room as well as teleconferences. On the conference list screen 230, conference information in the conference information storage unit 5001, for which the logged-in user has a viewing authority, is displayed. The record of moving image stored in the information storage unit 1001 may be further organized on the conference list screen 230.

The conference list screen 230 is displayed when the user selects a conference list tab 231 on the initial screen 200 of FIG. 42. On the conference list screen 230, a list 236 of the records of conference for which the user has the viewing authority is displayed. A person who schedules a conference (a person who creates minutes of the conference) can set the viewing authority for a participant of the conference. The list of conferences may be a list of stored records of conference, a list of scheduled conferences, or a list of conference data.

The conference list screen 230 includes items of a check box 232, an update date and time 233, a title 234, and a status 235.

The check box 232 receives selection of a recorded file. The check box 232 is used when the user desires to collectively delete recorded files.

The update date and time 233 indicates a start time or an end time of recording of the composite moving image. In a case where the composite moving image is edited, the update date and time 233 indicates the date and time of the editing.

The title 234 indicates the title (such as an agenda) of the conference. The title may be transcribed from the conference information or set by the user.

The status 235 indicates whether the composite moving image has been uploaded to the information processing system 50. In a case where the composite moving image has not been uploaded, “LOCAL PC” is displayed. In a case where the composite moving image has been uploaded, “UPLOADED” is displayed. In the case where the composite moving image has not been uploaded, an upload button is displayed. In a case where there is a composite moving image that has not yet been uploaded, it is desirable that the information recording application 41 automatically uploads the composite moving image when the user logs into the information processing system 50.

When the user selects a title from the list 236 of the composite moving images with a pointing device as desired, the information recording application 41 displays a record and replay screen. The description of the record and replay screen is omitted in the present embodiment. On the record and replay screen, the composite moving image can be replayed.

It is desirable that the user is allowed to narrow down the conferences by using the update date and time, the title, a keyword, or the like. In a case where the user has a difficulty in finding a desired conference due to a large number of conferences being displayed, it is desirable that the user is allowed to input a word or phrase in a search function to narrow down the records of conference based on the word or phrase included in speech in the conference or the title of the conference. The search function allows the user to find a desired record of conference in a short time even when the number of the records of conference is large. The conference list screen 230 may allow the user to sort the conferences by using the update date and time or the title.

Operation and Processing of Recording

FIG. 46 is a sequence chart illustrating an example of processing executed by the information recording application 41 to record a panoramic image, a talker image, and an application screen, according to the present embodiment. It is assumed that the participation in the conference and the muting control have already been completed.

S201: The user operates the teleconference application 42 to start the teleconference. In this example, it is assumed that the teleconference is started between the teleconference application 42 of the own site 102 and the teleconference application 42 of the other site 101. The teleconference application 42 of the own site 102 transmits an image captured by the camera included in the meeting device 6 ( ) and audio collected by the microphone included in the meeting device 60 to the teleconference application 42 of the other site 101. The teleconference application 42 of the other site 101 displays the received image on the display and outputs the received audio from the speaker. Similarly, the teleconference application 42 of the other site 101 transmits an image captured by a camera included in another meeting device 60 and audio collected by a microphone included in the other meeting device 60 to the teleconference application 42 of the own site 102. The teleconference application 42 of the own site 102 displays the received image on the display and outputs the received audio from the speaker. Each teleconference application 42 repeats these processes to implement the teleconference.

S202: The user inputs settings relating to recording on the recording setting screen 210 of FIG. 43 provided by the information recording application 41. The operation reception unit 12 implemented by the information recording application 41 receives the settings. In this example, a description is given on the assumption that both the camera toggle button 211 and the PC screen toggle button 212 are set to on.

S203: When the user operates to start recording, the recording control unit 17 implemented by the information recording application 41 starts the recording.

S204: The application screen acquisition unit 14 implemented by the information recording application 41 requests a screen of an application selected by the user from the selected application. More specifically, the application screen acquisition unit 14 acquires the screen of the application via the OS. In FIG. 46, a description is given on the assumption that the application selected by the user is the teleconference application 42.

S205: The recording control unit 17 implemented by the information recording application 41 notifies the meeting device 60 of the start of recording via the device communication unit 16. With the notification, the recording control unit 17 preferably transmits information indicating that the camera toggle button 211 is on (a request for a panoramic image and a talker image). The meeting device 60 transmits the panoramic image and the talker image to the information recording application 41 regardless of the presence or absence of the request.

S206: In response to receiving the notification of the start of recording, the terminal communication unit 61 of the meeting device 60 assigns a recording ID that is unique and transmits the recording ID to the information recording application 41. In one example, the information recording application 41 assigns the recording ID. In another example, the recording ID is acquired from the information processing system 50.

S207: The audio acquisition unit 15 implemented by the information recording application 41 acquires audio data output by the terminal apparatus 10 (audio data received by the teleconference application 42).

S208: The device communication unit 16 transmits the audio data acquired by the audio acquisition unit 15 and a synthesizing request to the meeting device 60.

S209: When the terminal communication unit 61 of the meeting device 60 receives the audio data and the synthesizing request, the audio synthesis unit 65 synthesizes the received audio data with audio of the surroundings collected by the audio collection unit 64. For example, the audio synthesis unit 65 adds the two audio data items together. Since clear audio around the meeting device 60 is recorded, the accuracy of converting audio especially around the meeting device 60 (in the conference room) into text data increases.

The terminal apparatus 10 is also capable of performing the synthesis of the audio. Alternatively, the recording function may be distributed to the meeting device 60, and the audio processing function may be distributed to the terminal apparatus 10. In this case, load on the meeting device 60 is reduced.

S210: Further, the panoramic image generation unit 62 of the meeting device 60 generates a panoramic image, and the talker image generation unit 63 generates a talker image.

S211: The device communication unit 16 implemented by the information recording application 41 repeatedly acquires the panoramic image and the talker image from the meeting device 60. Further, the device communication unit 16 repeatedly acquires the synthesized audio data from the meeting device 60. The device communication unit 16 may request the meeting device 60 to acquire such images and data. Alternatively, the meeting device 60 that has received the information indicating that the camera toggle button 211 is on may automatically transmit the panoramic image and the talker image to the information recording application 41. The meeting device 60 that has received the synthesizing request of audio data may automatically transmit the synthesized audio data to the information recording application 41.

S212: The recording control unit 17 implemented by the information recording application 41 generates a combined image by arranging the screen of the application acquired from the teleconference application 42, the panoramic image, and the talker image side by side. The recording control unit 17 repeatedly generates the combined image and designates each combined image to a frame forming a moving image, to generate a composite moving image. In addition, the recording control unit 17 stores the audio data received from the meeting device 60.

The information recording application 41 repeats the above-described steps S207 to S212.

S213: When the teleconference ends and the recording is no longer necessary, the user instructs the information recording application 41 to end the recording (for example, pressing the stop recording button 227). The operation reception unit 12 implemented by the information recording application 41 receives the instruction to end the recording.

S214: The device communication unit 16 implemented by the information recording application 41 notifies the meeting device 60 of the end of recording. The meeting device 60 continues the generation of the panoramic image and the talker image, and the synthesis of the audio. The meeting device 60 may change the processing load by, for example, changing the resolution or the frame rates (frames per second) depending on whether or not the recording is in progress.

S215: The recording control unit 17 implemented by the information recording application 41 combines the composite moving image with the audio data, to generate the composite moving image with audio.

S216: In a case where the user ticks the check box 215 associated with “Transcription starts automatically after uploading the record” on the recording setting screen 210, the audio data processing unit 18 requests the information processing system 50 to convert the audio data into text data. Specifically, the audio data processing unit 18 designates the URL of the storage location and transmits a request for converting the audio data combined with the composite moving image to the information processing system 50 together with the conference ID and the recording ID via the communication unit 11.

S217: The communication unit 51 of the information processing system 50 receives the request for converting the audio data, and the text conversion unit 56 converts the audio data into text data using the speech recognition service system 80. The communication unit 51 stores the text data in the same storage location (URL of the storage service system 70) as the storage location of the composite moving image. The text data is associated with the composite moving image by the conference ID and the recording ID in the record storage unit 5002. In another example, the text data may be managed by the communication management unit 54 of the information processing system 50 and stored in the storage unit 5000. In another example, the terminal apparatus 10 may request the speech recognition service system 80 to perform speech recognition, and may store text data acquired from the speech recognition service system 80 in the storage location. In the example above, the speech recognition service system 80 returns the converted text data to the information processing system 50. In another example, the speech recognition service system 80 directly transmits the text data to the URL of the storage location. The speech recognition service system 80 may be selected or switched among a plurality of services according to setting information set in the information processing system 50 by the user.

S218: The upload unit 20 implemented by the information recording application 41 stores the composite moving image in the storage location of the composite moving image via the communication unit 11. The composite moving image is associated with the conference ID and the recording ID in the record storage unit 5002. Having been uploaded is recorded in the composite moving image.

S219: The user operates the electronic whiteboard 2 to end the teleconference. Alternatively, the user may operate the terminal apparatus 10 to end the teleconference, and the terminal apparatus 10 transmits the notification of the end of the teleconference to the electronic whiteboard 2. In this case, the notification of the end of the teleconference may be transmitted to the electronic whiteboard 2 via the information processing system 50.

S220: The communication unit 36 of the electronic whiteboard 2 transmits object data displayed in the teleconference (written by hand, for example) to the information processing system 50 with designation of the conference ID. Alternatively, the communication unit 36 may transmit the device identifier of the electronic whiteboard 2 as the designation, instead of the conference ID, to the information processing system 50. In this case, the conference ID is identified by the association information.

S221: The information processing system 50 stores the object data in the same storage location as the storage location of the composite moving image and the like based on the conference ID.

Since the user is notified of the storage location, the user can share the composite moving image with other participants by sending the storage location via e-mail or the like. Even when the composite moving image, the audio data, the text data, and the object data are generated by different devices or apparatuses, these image and data are collectively stored in one storage location. Thus, the user or the like can view the image and the data later in a simple manner.

The processing from steps S207 to S212 does not have to be executed in the order illustrated in FIG. 46. For example, the order of the synthesis of the audio data and the generation of the combined image may be switched.

As described above, since the meeting device 60 according to the present embodiment requests the electronic whiteboard 2 displaying the two-dimensional code to be muted, an appropriate device is muted without a mistake. In addition, in a case where the user desires to output audio from the meeting device 60 located at the center of the participants in the conference and mute the microphone 440 of the electronic whiteboard 2 for receiving audio, such control cannot be performed in the conventional technology. In the present embodiment, the device is not mistaken as described above.

Variations

The above-described embodiment is illustrative and does not limit the present disclosure. Thus, numerous additional modifications and variations are possible in light of the above teachings. For example, elements and/or features of different illustrative embodiments may be combined with each other and/or substituted for each other within the scope of the present disclosure. Any one of the above-described operations may be performed in various other ways, for example, in an order different from the one described above.

For example, the terminal apparatus 10 and the meeting device 60 may be configured as a single entity. The meeting device 60 may be externally attached to the terminal apparatus 10. The meeting device 60 may be implemented by a spherical camera, a microphone, and a speaker connected to one another by cables.

Another meeting device 60 may be provided also at the other site 101. The other meeting device 60 at the other site 101 separately generates a composite moving image and text data. A plurality of meeting devices 60 may be provided at a single site. In this case, the plurality of meeting devices 60 respectively creates records of conference.

The arrangement of the panoramic image 203, the talker images 204, and the screen of the application in the composite moving image used in the present embodiment is merely an example. The panoramic image 203 may be displayed below the talker images 204. The user may change the arrangement. The user may individually switch between display and non-display of the panoramic image 203 and the talker images 204 during replay.

The functional configurations illustrated in FIG. 9 are divided according to main functions in order to facilitate understanding of processing executed by the terminal apparatus 10, the meeting device 60, and the information processing system 50. Each processing unit or each specific name of the processing unit is not to limit the scope of the present disclosure. The processing executed by the terminal apparatus 10, the meeting device 60, and the information processing system 50 may be divided into more processing units in accordance with the content of the processing. In addition, a single processing unit can be divided to include a larger number of processing units.

The apparatuses or devices described in the above-described embodiment are merely one example of plural computing environments that implement the embodiment disclosed herein. In some embodiments, the information processing system 50 includes a plurality of computing devices, such as a server cluster. The plurality of computing devices communicates with one another through any type of communication link including, for example, a network or a shared memory, and performs the operations described in the present disclosure.

Further, the information processing system 50 may be configured to share the disclosed processing steps, for example, the processing illustrated in FIG. 16, in various combinations. For example, processing executed by a predetermined unit may be executed by a plurality of information processing apparatuses included in the information processing system 50. Further, each element of the information processing system 50 may be integrated into one server or may be divided into a plurality of apparatuses.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

1. A system comprising a first apparatus and a second apparatus,
the first apparatus including first circuitry configured to:
input and output audio;
acquire information on the second apparatus output from the second apparatus; and
transmit the information on the second apparatus acquired from the second apparatus to a terminal apparatus,
the second apparatus including second circuitry configured to:
input and output audio;
output the information on the second apparatus; and
in response to a request for adjusting audio volume of the second apparatus received from the terminal apparatus via a network, adjust the volume of at least one of the audio input by the second apparatus or the audio output by the second apparatus.

2. The system according to claim 1, wherein:
the second apparatus includes a display,
the second circuitry is configured to output the information on the second apparatus as visible information displayed on the display,
the first apparatus includes an imaging device, and
the first circuitry is configured to acquire the information on the second apparatus by capturing the visible information with the imaging device.

3. The system according to claim 1, wherein:
the second circuitry is configured to output the information on the second apparatus as audio,
the first apparatus includes a microphone, and
the first circuitry is configured to acquire the information on the second apparatus by collecting the audio output by the second circuitry with the microphone.

4. The system according to claim 1, wherein:
the second circuitry is configured to transmit the information on the second apparatus by short-range wireless communication, and
the first circuitry is configured to acquire the information on the second apparatus transmitted by the short-range wireless communication.

5. The system according to claim 1, further comprising an information processing server including third circuitry configured to receive information on a communication held in the system, wherein:
the second circuitry is further configured to:
in response to a request for participation of the second apparatus in a communication, transmit a notification of participation of the second apparatus in the communication to the information processing system; and
start outputting the information on the second apparatus,
the first circuitry is further configured to:
in a case where the terminal apparatus receives a request for participation in the communication, transmit a notification of participation of the first apparatus in the communication to the information processing system; and
start acquiring the information on the second apparatus, and
the third circuitry of the information processing system is configured to associate the first apparatus with the second apparatus in a memory.

6. The system according to claim 1, comprising an information processing server including third circuitry configured to receive information on a communication held in the system, wherein:
the second circuitry is configured to:
in response to a request for participation of the second apparatus in the communication, transmit the notification of participation of the second apparatus in the communication to the information processing system; and
start outputting the information on the second apparatus,
the first circuitry is configured to, in a case where the terminal apparatus receives a request for participation in the communication, transmit the notification of participation of the first apparatus in the communication to the information processing system,
the third circuitry is configured to, in a case where the terminal apparatus and the second apparatus receive the request for participation in the communication, request the first apparatus to start acquiring the information via the terminal apparatus.

7. The system according to claim 1, wherein:
the information on the second apparatus is an internet protocol address of the second apparatus, and
the second circuitry is configured to receive the request for adjusting audio volume addressed to the internet protocol address of the second apparatus from the terminal apparatus connected to a same network to which the second apparatus is connected.

8. The system according to claim 5, wherein:
the information on the second apparatus is a device identifier of the second apparatus, and
in response to the request for adjusting audio volume with designation of the device identifier of the second apparatus from the terminal apparatus, the third circuitry of the information processing system is configured to transmit the request for adjusting audio volume to the second apparatus identified by the device identifier of the second apparatus.

9. The system according to claim 5, wherein:
in response to the request for adjusting the audio volume with the designation of the device identifier of the second apparatus from the terminal apparatus, the third circuitry of the information processing system is configured to request a teleconference service system to stop audio transmission to the second apparatus identified by the device identifier of the second apparatus and stop audio transmission from the second apparatus to another site.

10. The system according to claim 5, wherein:
in a case where the audio volume is already adjusted at a time of receiving the request for participation in the communication, the second circuitry does not output the information on the second apparatus.

11. The according to claim 1, wherein:
in response to receiving a notification of an end of the communication, the second circuitry is configured to cancel adjustment of the audio volume.

12. The system according to claim 1, wherein:
in a case where the terminal apparatus receives the notification of the end of the communication, the second apparatus receives a request for canceling the adjustment of the audio volume from the terminal apparatus; and
in response to the request for canceling the adjustment of the audio volume from the terminal apparatus, the second apparatus cancels the adjustment of the audio volume.

13. The system according to claim 5, wherein:
in response to detecting disconnection of communication with the terminal apparatus, the third circuitry of the information processing system is configured to transmit a request for canceling the adjustment of the audio volume to the second apparatus, and
in response to the request for canceling the adjustment of the audio volume, the second circuitry is configured to cancel the adjustment of the audio volume.

14. The system according to claim 1, wherein:
the second apparatus includes a display,
the second circuitry is configured to output the information on the second apparatus as visible information displayed on the display and keep displaying the visible information on the display for a certain time, and
in response to detecting an operation to the second apparatus, the second circuitry is configured to stop displaying the information even within the certain time.

15. A system comprising a first apparatus and a second apparatus,
the first apparatus including first circuitry configured to:
input and output audio;
acquire information on the second apparatus output from the second apparatus; and
transmit the information on the second apparatus acquired from the second apparatus to a network,
the second apparatus including second circuitry configured to:
input and output audio;
output the information on the second apparatus; and
in response to a request for adjusting audio volume of the second apparatus received via the network, adjust the volume of at least one of the audio input by the second apparatus or the audio output by the second apparatus.

16. A method for adjusting audio volume performed by a system including a first apparatus that inputs and outputs audio and a second apparatus that inputs and outputs audio, the method comprising:
outputting information on the second apparatus from the second apparatus;
with the first apparatus, acquiring the information on the second apparatus output from the second apparatus;
transmitting, from the first apparatus to a terminal apparatus, the information on the second apparatus acquired from the second apparatus; and
in response to a request for adjusting audio volume of the second apparatus received from the terminal apparatus via a network, adjusting the volume of at least one of the audio input by the second apparatus or the audio output by the second apparatus.

17. An apparatus comprising circuitry configured to:
communicate, via a network, with another apparatus that inputs and outputs audio;
input and output audio;
output information on the apparatus to another apparatus, the information on the apparatus being transmitted from the another apparatus to a terminal apparatus; and
in response to a request for adjusting audio volume of the apparatus received from the terminal apparatus via the network, adjust the volume of at least one of the audio input by the apparatus or the audio output by the apparatus, the terminal apparatus having received, from a user, a request for participation of the another apparatus in a communication in which the apparatus participates.

18. An apparatus comprising circuitry configured to:
communicate, via a network, with another apparatus that inputs and outputs audio;
input and output audio;
acquire information on the another apparatus output from the another apparatus; and
transmit the information on the another apparatus acquired from the another apparatus to a terminal apparatus having received, from a user, a request for participation of the apparatus in a communication in which the another apparatus participates.

19. An apparatus comprising circuitry configured to:
communicate with another apparatus that inputs and outputs audio;
input and output audio;
acquire information on the another apparatus output from the another apparatus; and
in accordance with the information on the another apparatus acquired from the another apparatus, adjust volume of at least one of the audio input by the apparatus or the audio output by the apparatus.
